(19) United States
(12) Patent Application Publication
(10) Pub. No.: US 2014/0168277 A1
(43) Pub. Date: Jun. 19, 2014

(54) Adaptive Presentation of Content

(71) Applicants: Alex Ashley, Redhill (GB); Laurent Chauvier, Villlevallier (FR); Nicolas Gaude, Issy Les Moulineaux (FR); Hugo Latapie, Long Beach, CA (US); Kevin A. Murray, Fordingbridge (GB); Simon John Parnall, Kingswood (GB); James Geoffrey Walker, Winchester (GB); Neil Cormican, London (GB); Simon Dyke, Southampton (GB); Vincent Sattler, Paris (FR); Alex Ruelle, Colombes (FR); Jonathan Pollen, Jerusalem (IL); Meir Gerenstadt, Bet Shemesh (IL)

(72) Inventors: Alex Ashley, Redhill (GB); Laurent Chauvier, Villlevallier (FR); Nicolas Gaude, Issy Les Moulineaux (FR); Hugo Latapie, Long Beach, CA (US); Kevin A. Murray, Fordingbridge (GB); Simon John Parnall, Kingswood (GB); James Geoffrey Walker, Winchester (GB); Neil Cormican, London (GB); Simon Dyke, Southampton (GB); Vincent Sattler, Paris (FR); Alex Ruelle, Colombes (FR); Jonathan Pollen, Jerusalem (IL); Meir Gerenstadt, Bet Shemesh (IL)

(73) Assignee: Cisco Technology Inc., San Jose, CA (US)

(21) Appl. No.: 14/115,811

(22) PCT Filed: May 10, 2012
(86) PCT No.: PCT/IB2012/052326

§ 371 Date: Feb. 25, 2014

(30) Foreign Application Priority Data
May 10, 2011 (GB) 1107703.9
Sep. 6, 2011 (GB) 1115375.6

(51) Int. Cl. G06T 3/20

(52) U.S. Cl. CPC G06T 3/20
USPC 345/672

(57) ABSTRACT

A method of operating a client device within a viewing environment is described. The method includes: receiving content at a client device, presenting the content to a viewer by rendering the content as rendered content on a display surface in operable communication with the client device; receiving engagement data at the client device, the engagement data indicating a level of engagement with the content of at least one user who is viewing the rendered content; and adapting presentation of the content in dependence on the engagement data by changing how the content is rendered on the display surface. Related systems, apparatus, and methods are also described.

The present invention relates to a client device and a method of operating a client device in a viewing environment. More specifically it relates to systems and methods for adapting the presentation of content in a variable viewing environment.

Evolving display technologies, audio technologies and home automation technologies offer the potential for more realistic, immersive, varied and changing media consumption experiences. It is expected that large, high resolution, affordable domestic ‘lifestyle display surfaces’ will soon be available on the market. Such display surfaces (or surfaces), enabled by thin or no-bezel tile-able panel technology (i.e. each surface could comprise one or more displays), or high-resolution projectors, could cover a substantial part of, or an entire wall. These surfaces could be dynamically augmented both by users' personal displays (or companion devices), and other displays or surfaces being added and removed from the overall viewing environment.

On such display surfaces, full screen presentation of multimedia content may not be appropriate for all types of multimedia content or viewing scenarios, even when the content is available in ultra high-definition (e.g. 7,680×4,320 pixels). For example, while the viewing experience of watching a movie in the evening may be enhanced by immersive, large screen presentation in dim lighting with high dynamic range surround sound audio, such multimedia presentation may be impractical for a family that wants to share the display surface over breakfast with some catching up on the news headlines, others looking at the weather and traffic reports and others viewing their favourite cartoon.

There is thus provided in accordance with an embodiment of the present invention a method for operating a client device within a viewing environment the method including: receiving content at a client device, presenting the content to a viewer by rendering the content as rendered content on a display surface in operable communication with the client device; receiving engagement data at the client device, the engagement data indicating a level of engagement with the content of at least one user who is viewing the rendered content; and adapting presentation of the content in dependence on the engagement data by changing how the content is rendered on the display surface.

Further, in accordance with an embodiment of the present invention, the content is presented at a location on the display surface and the adapting includes changing the location where the content is presented.

Still further, in accordance with an embodiment of the present invention, the content is presented at a size on the display surface and the adapting includes changing the size at which the content is presented.

Additionally, in accordance with an embodiment of the present invention, the content is presented across a plurality of display surfaces and the adapting includes changing which of the plurality of surfaces the content is presented on.

Moreover, in accordance with an embodiment of the present invention, the method further includes temporally synchronising the presentation of the content across the plurality of display surfaces.

Further, in accordance with an embodiment of the present invention, one of the plurality of display surfaces includes a master and the remaining display surfaces in the plurality of display surfaces include slaves which are synchronised to the master.

Still further, in accordance with an embodiment of the present invention, the adapting presentation of the content includes changing audio presentation of the content by changing one or more of: audio level, audio dynamic range, audio position, audio balance.

Additionally, in accordance with an embodiment of the present invention, the adapting presentation of the content further includes adapting presentation of the content in dependence on metadata associated with the content.

Moreover, in accordance with an embodiment of the present invention, the metadata includes data to explicitly modify how the content is to be presented.

Further, in accordance with an embodiment of the present invention, the metadata includes a physical size at which to render the content.

Still further, in accordance with an embodiment of the present invention, the adapting presentation of the content additionally includes changing a lighting level of the viewing environment.

Additionally, in accordance with an embodiment of the present invention, rendering the content causes execution of a search query, the search query searching for additional content that is contextually relevant to the content, and the adapting presentation of the content further includes simultaneously rendering the additional content with the content.

Moreover, in accordance with an embodiment of the present invention, adapting presentation of the content additionally includes adapting presentation of the additional content.

Further, in accordance with an embodiment of the present invention, the level of engagement is determined by analysing at least one of: audio signals in the viewing environment not caused by presenting the content; a position of the viewer in the viewing environment; a direction of gaze of the viewer; a degree of movement of the viewer; usage of a remote control device by the viewer; content previously viewed by the viewer; whether the content is being viewed live or a played back recording; viewer behaviour during the presenting the content; user interaction with other electronic devices; a time of day of viewing the content.

Still further, in accordance with an embodiment of the present invention, the level of engagement is determined from data input by the viewer explicitly defining the level of engagement.

Additionally, in accordance with an embodiment of the present invention, the method further includes transmitting a representation of how the content is presented on the display surface to a handheld device in operable communication with the client device; and displaying the representation on the handheld device.

Moreover, in accordance with an embodiment of the present invention, the representation includes a link to further content that is contextually relevant to the content, the method further including receiving a selection of the link by the viewer; sending a request for the further content on receiving the selection; receiving the further content; and presenting the further content to the viewer.

Further, in accordance with an embodiment of the present invention, the method further includes: receiving a message from the additional handheld device indicating that the viewer has modified the representation; and further adapting presentation of the content on the display surface in response to the message.

Still further, in accordance with an embodiment of the present invention, the method further includes: receiving a domotic input unconnected to the content from a home automation system in operable communication with the client device; and adapting presentation of the content in response to the domotic input.

Additionally, in accordance with an embodiment of the present invention, the adapting presentation of the content in response to domotic input includes interrupting presentation of the content to present the domotic input.

Moreover, in accordance with an embodiment of the present invention, the interrupting presentation of the content occurs only if the level of engagement is less than an interrupt threshold.

Further, in accordance with an embodiment of the present invention, the content includes a plurality of content components each presented at a location and size on the display surface, and the adapting presentation of the content includes changing the location and/or size for at least one of the plurality of the content components.

There is also provided in accordance with a further embodiment of the present invention, a client device operable within a viewing environment, the client device including: means for receiving content; means for presenting the content to a viewer by rendering the content as rendered content on a display surface in operable communication with the client device; means for receiving engagement data, the engagement data indicating a level of engagement with the content of at least one user who is viewing the rendered content; and means for adapting presentation of the content in dependence on the engagement data by changing how the content is rendered on the display surface.

There is also provided in accordance with another embodiment of the present invention, a carrier medium carrying computer readable code for controlling a suitable computer to carry out the method as described above.

There is also provided in accordance with a further embodiment of the present invention, a carrier medium carrying computer readable code for configuring a suitable computer as the client device as described above.

The present invention will be understood and appreciated more fully from the following detailed description, taken in conjunction with the drawings in which:

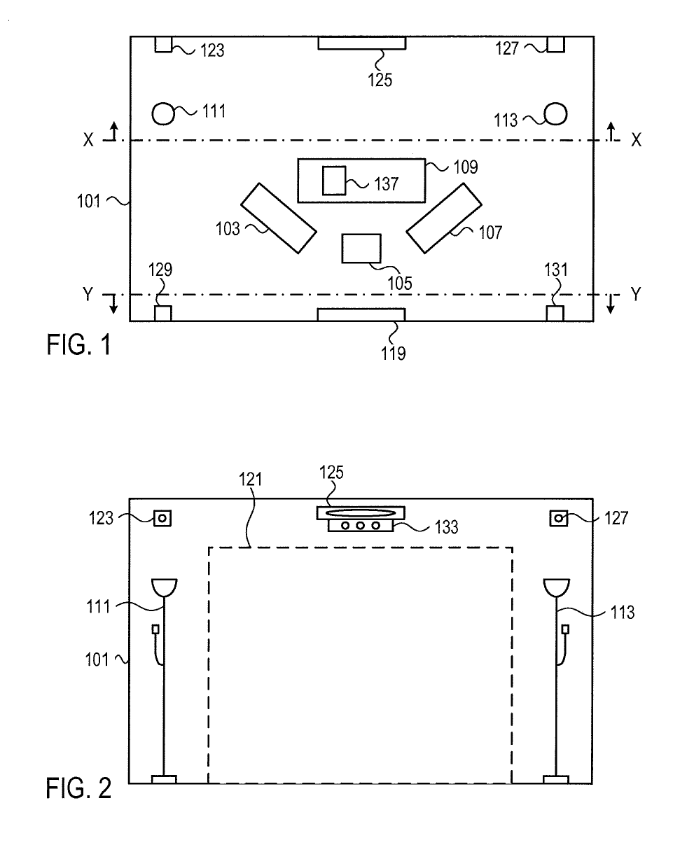

FIG. 1 is a simplified pictorial plan view of a viewing environment in accordance with embodiments of the present invention;

FIG. 2 is a simplified pictorial cross sectional view of the front of the viewing environment of FIG. 1;

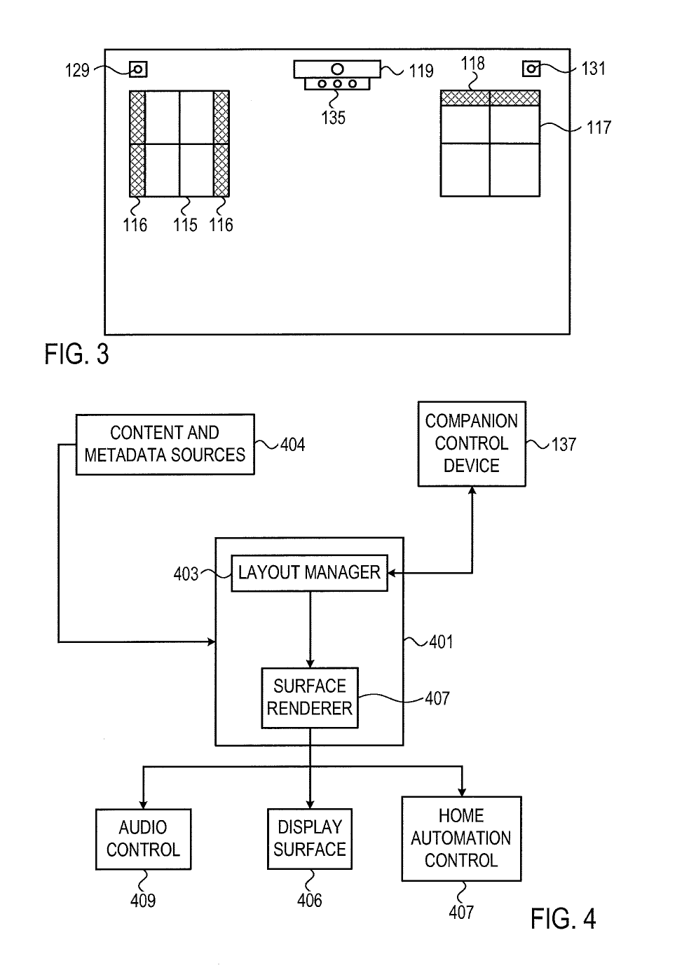

FIG. 3 is a simplified pictorial cross sectional view of the rear of the viewing environment of FIG. 1;

FIG. 4 is a simplified pictorial illustration of an architecture according to embodiments of the present invention;

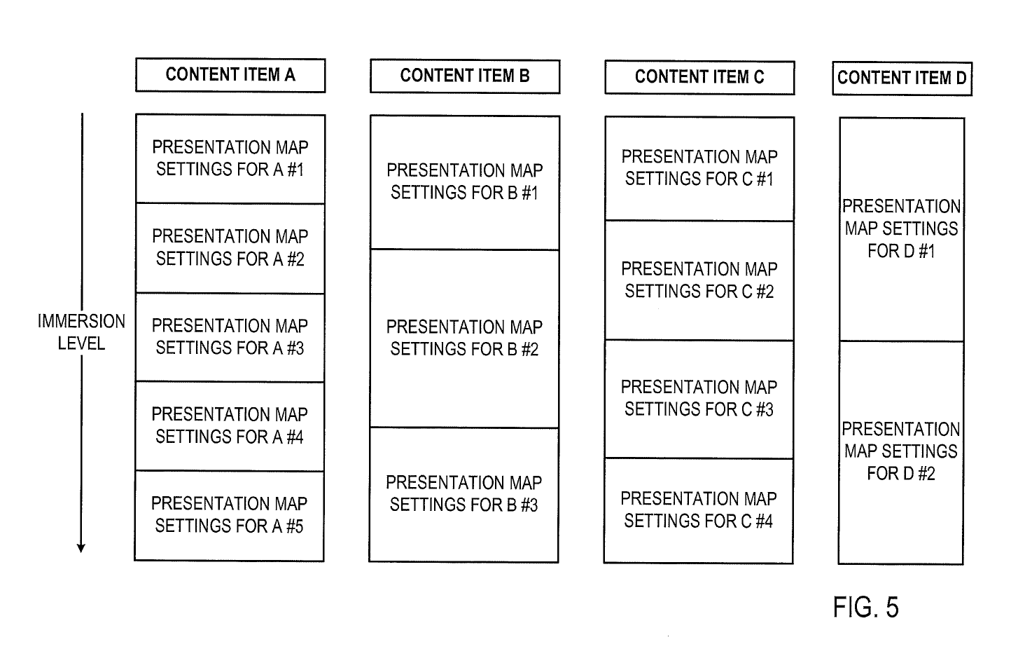

FIG. 5 is a simplified pictorial illustration of a presentation map scheme according to embodiments of the present invention; and

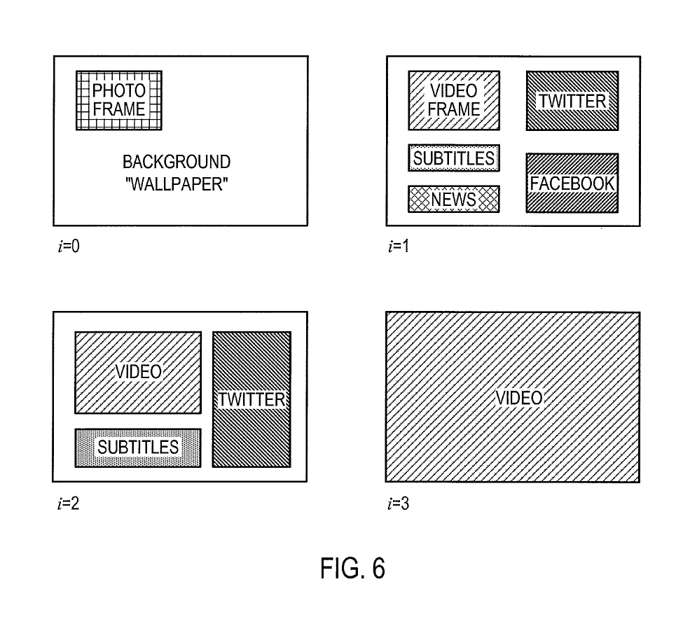

FIG. 6 is a simplified pictorial illustration of some example layouts corresponding to a presentation map in accordance with embodiments of the present invention;

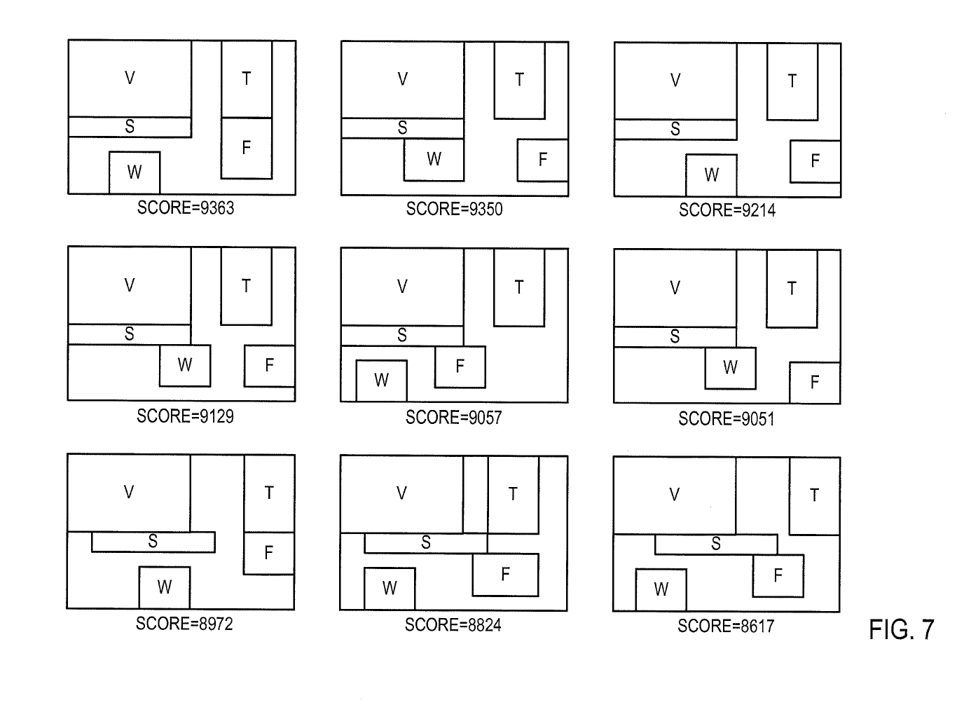

FIG. 7 is an example set of scored layouts generated by a layout algorithm according to embodiments of the present invention;

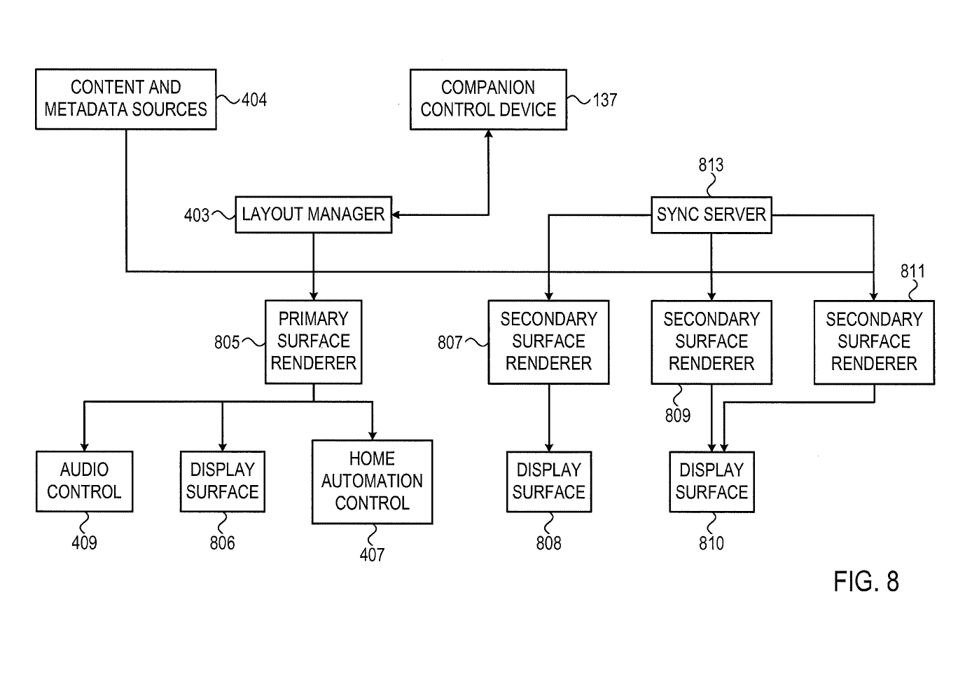

FIG. 8 is a simplified pictorial illustration of an architecture according to embodiments of the present invention;

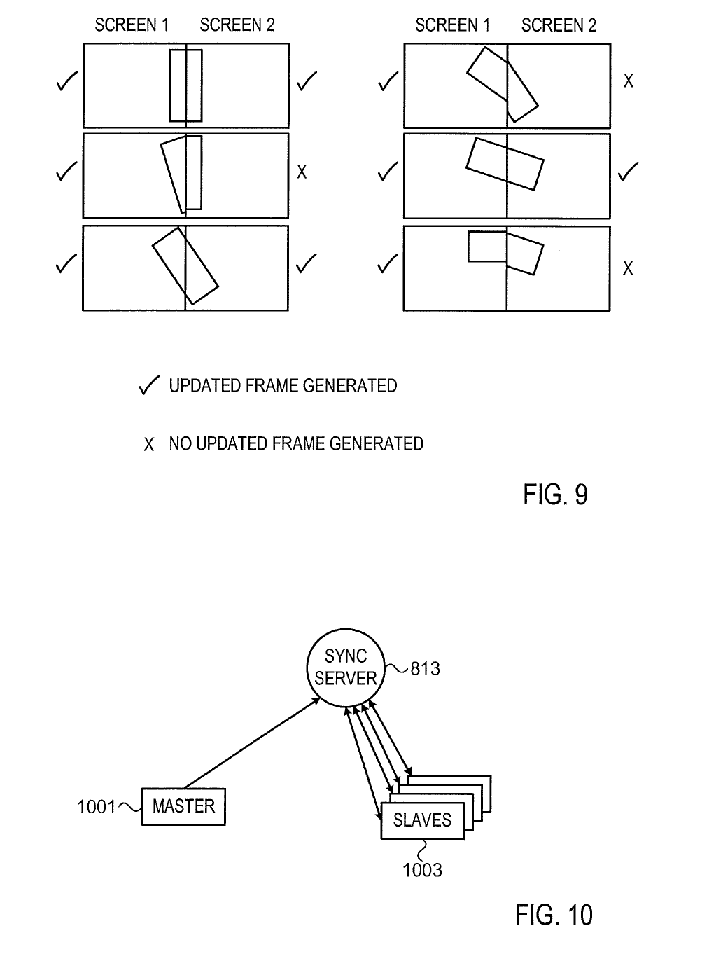

FIG. 9 illustrates a potential synchronisation problem when displaying content on multiple display surfaces;

FIG. 10 is a simplified pictorial illustration of an architecture according to embodiments of the present invention;

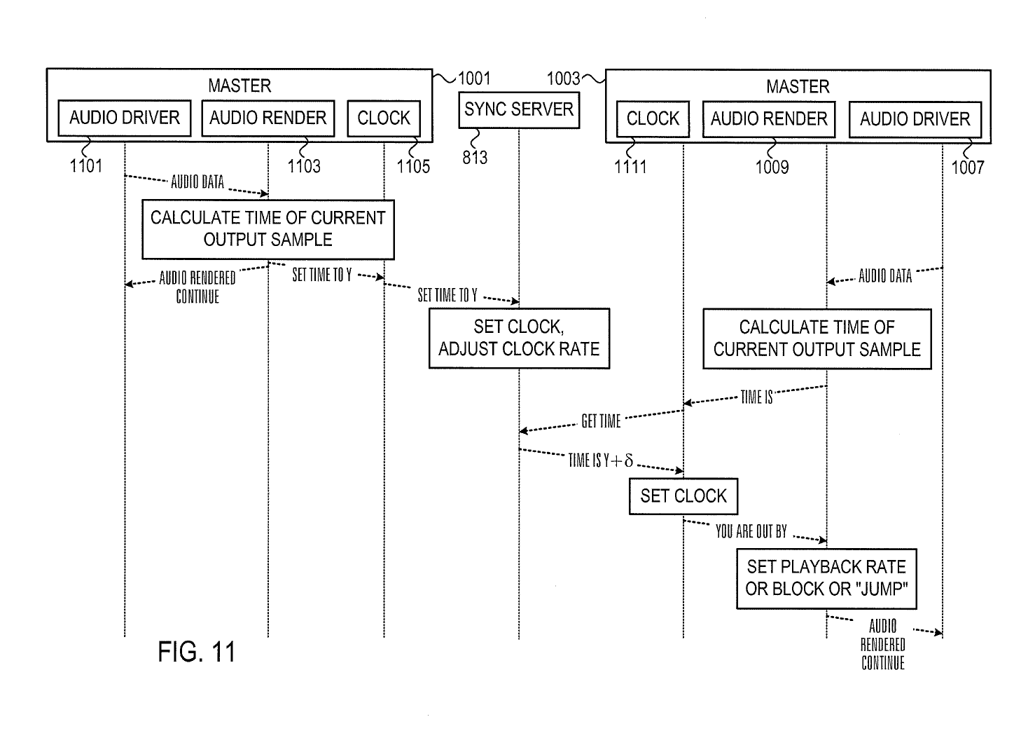

FIG. 11 is an illustration of a message flow according to embodiments of the present invention;

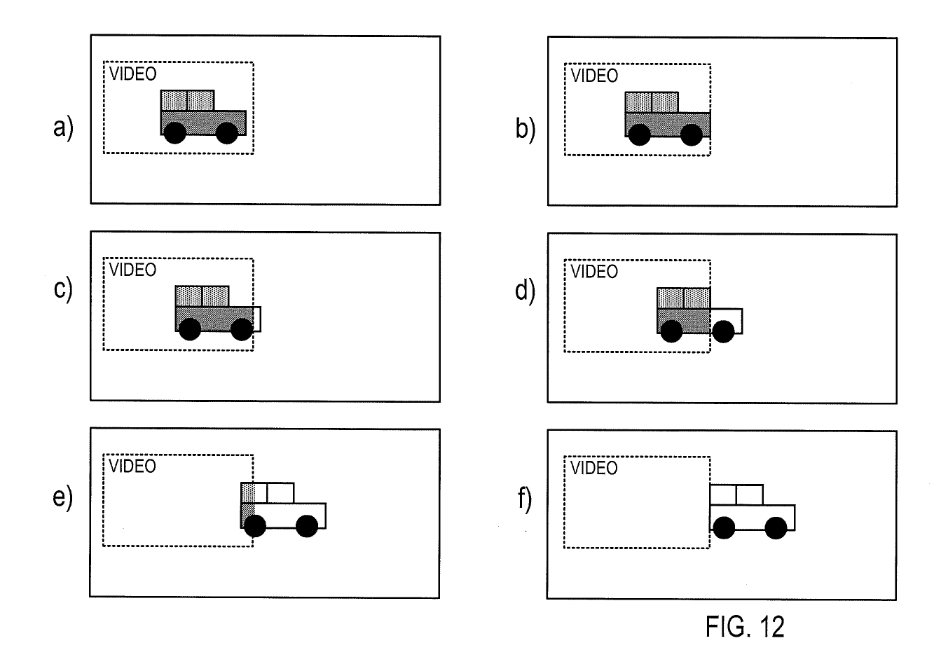

FIG. 12 is a simplified pictorial illustration of the displaying of video and graphics on multiple display surfaces according to embodiments of the present invention; and

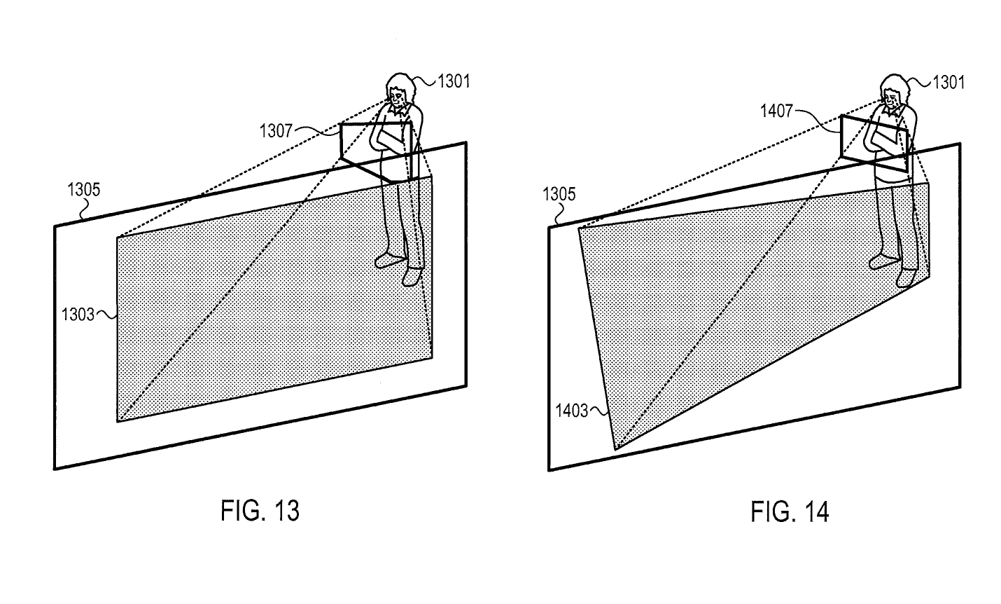

FIGS. 13-31 relate to a method and system of viewer perspective correction according to embodiments of the present invention.

Reference is now made to FIGS. 1 to 3, which show various views of a domestic viewing environment 101. FIG. 1 shows a plan view of domestic viewing environment 101. FIG. 2 shows a cross sectional view of environment 101 along the line X-X (i.e. a view of the front wall of environment 101). FIG. 3 shows a cross sectional view of environment 101 along the line Y-Y (i.e. a view of the rear wall of environment 101) is shown in FIG. 3.

Viewing environment 101 comprises: seats 103/105/107; a table 109; electronically/remotely controllable lights 111/113; and windows 115/117 having electronically/remotely controllable window blinds 116/118 respectively. Lights 111/113 and blinds 116/118 are typically controlled via a home automation control system (not shown).

Also included in viewing environment 101 (but not shown) is a client device (e.g. set top box (STB) or other audio/video rendering device such as an integrated receiver/decoder (IRD); PC; server, etc.) that is operable to output content for display.

The range of content that can be received by the client device and displayed typically includes, but is not limited to: audio/video (AV) content (e.g. in the form of regular scheduled transmissions or in the form of video-on-demand (VOD), near video-on-demand (NVOD) or streamed transmissions); domotic content & feeds (e.g. photos, in-home webcams and monitors, etc.); online media content (e.g. video, news and social feeds etc.); messaging (e.g. emails, instant messages, etc.); content metadata (e.g. DVB-SI metadata, TV Anytime metadata, etc.) Other forms of content receivable by the client device will be apparent to someone skilled in the art.

The content received by client device is typically received from a range of content sources over a communications network such as: a satellite based communication network; a cable based communication network; a conventional terrestrial broadcast television network; a telephony based communication network; a telephony based television broadcast network; a mobile-telephony based television broadcast network; an Internet Protocol (IP) television broadcast network; and a computer based communication network. In alternative embodiments, the communication network can be implemented by a one-way or two-way hybrid communication network, such as a combination cable-telephone network, a combination satellite-telephone network, a combination satellite-computer based communication network, or by any other appropriate network. In some embodiments, the content may be received from a content source at a gateway device that connects to one or more of the communications networks described above and distributes the content received over those communications network to the client device. Certain types of content (e.g. domotic content) are typically received over a local area network (e.g. a home network) sometimes directly by the client device and sometimes via the gateway device.

In the present embodiment, the client device outputs to a projector 119, which then displays the output video on a region 121 of the front wall of viewing environment 101. Alternatively, client device could output to a single, very large display screen mounted on the front wall, or to a tile-able, multi-screen display system mounted on the front wall. (It is to be noted that the system according to certain embodiments of the present invention could also be used with conventional/existing display technologies).

Client device is further operable to output audio to a multi-channel audio system having speakers 123/125/127/129/131 mounted at the front and rear of viewing environment 101. Such an audio system is typically controlled via an audio control system (not shown).

Also mounted at the front and rear of viewing environment 101 are sensors 133/135 operable to capture views of the viewing environment, both looking into the environment from above region 121, and towards region 121 from the rear of environment 101. In the present embodiment, the sensors 133/135 (e.g. Kinect™ sensors from Microsoft™) are typically horizontal bars connected to a small base with a motorized pivot however other forms of sensors are possible.

In further embodiments, sensors can be mounted anywhere in the viewing environment and a transform function (that uses scaling, translation and rotation functions) can be used to make such a setup equivalent to the setup described previously where the sensors are placed at the front and rear of the viewing environment.

In further embodiments, the sensors can be integrated into other devices such as handheld devices including smart phones, notebooks, tablets, etc.

The sensors, typically controlled via a sensor control system (not shown), typically feature some or all of: a camera (typically an RGB camera), depth sensor and a microphone (typically a multi-array microphone), which provide some or all of full-body 3D motion capture, facial recognition and voice recognition capabilities respectively. The depth sensors typically consist of infrared laser projectors combined with a monochrome CMOS sensors, which capture video data in 3D under any ambient light conditions. The sensing range of the depth sensor is typically adjustable, and the software is capable of automatically calibrating the sensor based on use and the physical environment, accommodating for the presence of furniture (e.g. seats 103/105/107/109, table 109, or other obstacles).

Software technology (e.g. analysis software such as the OpenNI middleware (http://www.openni.org/), OpenCV library (http://opencv.willowgarage.com/wiki/), CMU Sphinx toolkit (http://cmusphinx.sourceforge.net/) enables advanced gesture recognition, facial recognition and voice recognition and is capable of simultaneously tracking up to six people.

The client device is also operable to connect to the internet and to communicate with one or more companion devices (e.g. companion device 137 seen on top of table 109) over a suitable network technology (e.g. WiFi). Companion device 137 typically comprises a smartphone, tablet, notebook, etc. or other handheld device. Such network technology also enables the client device to communicate with and control lights 111/113 and window blinds 116/118 via the home automation control system.

The client device typically includes, or is associated with, a digital video recorder (DVR) that typically includes a high capacity storage device, such as a high capacity memory enabling the client device to record at least some of the AV content received in the storage device and display recorded AV content at a discretion of a user, at times selected by the user, and in accordance with preferences of the user and parameters defined by the user. The DVR also typically enables various trick modes that may enhance viewing experience of users such as, for example, fast forward or fast backward.

The client device typically accepts, via an input interface, user input from an input device that is operated by the user such as a remote control, or handheld companion device 137, running a suitable control application.

FIG. 4 shows the client device described above in relation to FIGS. 1-3 in the context of a single surface domestic viewing environment. The client device 401 hosts two functions: a layout manager 403; and a surface renderer 405. Layout manager 403 determines the arrangement of content items on the display surface 406 in response to user requests to view specific items of content. The user requests are typically generated via companion device 137 as described above. The content, received from content and metadata sources 404, typically includes, but is not limited to: audio/video (AV) content (e.g. in the form of regular scheduled transmissions or in the form of video-on-demand (VOD), near video-on-demand (NVOD) or streamed transmissions); domotic content & feeds (e.g. photos, in-home webcams and monitors, etc.); online media content (e.g. video, news and social feeds etc.); messaging (e.g. emails, instant messages, etc.); content metadata (e.g. DVB-SI metadata, TV Anytime metadata, etc.), as described previously. Surface renderer 405 renders the content onto the display surface under the control of layout manager 403. The client device also communicates with home automation control system 407 and audio control system 409, both described above.

According to embodiments of the present invention, the client device is operable to adapt the presentation of content according to several factors including content metadata; real-time analysis of the viewing environment 101; user control; etc. These factors will now be described in more detail.

Examples of how content metadata can be used to adapt the presentation of content will now be described:

The position and size of the presented video, the audio level, the audio dynamic range, the ambient lighting level can all be modified in accordance with metadata associated with the presented content, for example:
Genre (e.g. present content on full screen for a movie, or present content at a smaller size (i.e. sub-full screen) for news or current affairs programmes) etc.
Parental Rating (e.g. diminishing the size, hiding or applying a blur filter to video, reducing, silencing or muffling the audio level appropriately etc. for content which has a parental rating delta to detected viewers in the viewing environment (e.g. if content with a parental rating of 12 is being presented to an audience of ten year olds, it may be acceptable to blur the video, but content with a parental rating of 18 is completely hidden).
Viewer favorites/preferences (e.g. where the user has indicated a preference for a particular content subject (for example, a favorite actor within cast list, a favorite sports team, a favorite band, a favorite show/movie/television series etc.), whenever this is signaled via the content metadata, the content can be presented in a more immersive mode (e.g. scaled to occupy a larger screen area, with audio volume subtly increased.)

The position and size of the presented video, the audio level, the audio dynamic range, the ambient lighting level can all be modified in accordance with specifically authored presentation metadata. For example, the content creator or broadcaster could author and embed metadata to explicitly modify or control aspects of the presentation of specific content (e.g. a minimum, maximum or explicit physical size at which to render video in region 121, the audio dynamic range etc.) etc.

The position and size of the presented video can be adapted to accommodate the simultaneous on-screen presentation of other (typically contextually relevant) content, including, but not limited to:
navigation and discovery user interface and/or electronic program guide (EPG);
subtitles/closed captions;
tickers/banners/other digital on-screen graphics (dogs);
relevant web pages;
broadcast or online interactive (e.g. ‘red button’) applications;
social networking feeds for relevant topics (e.g. a Twitter feed associated with the content hashtag, or with the actors/presenters on-screen); etc.

Such content could be in a range of formats, including but not limited to text, RSS, raster graphics (e.g. bitmaps, JPEGs, PNGs), vector graphics (e.g. SVG), and interactive multimedia formats (e.g. Adobe Flash, Microsoft Silverlight, Java Applications and HTML5 and its various associated technologies (e.g. HTML, CSS, JavaScript, WebGL et al.)).

Such contextually relevant content is typically either in the form of editorially managed links (i.e. a manually generated/approved set of links to specific items of contextually relevant content), or in the form of search queries that are executed at the time the content is consumed, e.g. a twitter hashtag search, a general web search by keyword, a YouTube search by keyword, a vertical search engine search by keyword etc. These contextually relevant content links/queries can be delivered within a digital television broadcast multiplex or via the Internet using standard web-service technologies in a variety of formats, for example TV-Anytime.

Someone skilled in the art will appreciate that many other forms of metadata can be used to adapt the presentation of content. In certain embodiments of the present invention, the metadata can be analyzed by the client device in real time.

Examples of how a real time analysis of viewing environment 101 (including, but not limited to using sensors 133/135 running suitable software) can be used to adapt the presentation of content will now be described:

The presence and identity of users known to the system can be determined, and the presentation of content can then be adapted to reflect a particular user's personal preferences (e.g. showing a particular user's social network feed while they are watching the screen; or adapting the size of the presented video, the audio level, the audio dynamic range, the ambient lighting level etc. in dependence on preferences set by the particular user, etc.)

The position of a viewer in viewing environment 101 can be determined and the positioning and scaling of the presented content can be adapted as appropriate for that viewer (e.g. present the content directly opposite the viewing position such that the positioning of the presented content will depend on whether a viewer watches from seat 103, seat 105 or seat 107, etc.) More details are now described below.

It will be appreciated that if content is simply scaled to fit the available display surface area (e.g. when presenting content on the entire display surface; when multiple items of content share the display surface; etc.), then certain user interface (UI) elements such as text and lines might be too small to be readable by the viewer.

According to embodiments of the present invention, the position of a viewer in viewing environment 101 (e.g. the distance of a viewer from the display surface) can be determined and used to calculate a minimum text or graphics physical size to ensure legibility at the viewing distance. The system can use the calculated minimum text/graphics size, and the physical resolution of the display surface to ensure that any graphics and text that are scaled prior to presentation in a target area of the display surface are legible (i.e. larger than a calculated minimum size). If not larger than the calculated minimum size, either the graphics are not scaled below this minimum size or, a re-layout of the content can be triggered such that all text is rendered at that minimum size, which may lead to a reduction in the amount of content displayed within the target area of the display surface, but ensuring legibility at the viewer's viewing distance.

The distance at which a viewer selects to view the display surface from often depends on the size of the display surface. Typical recommended viewing ranges are shown in the table below:

| Surface Size (inches) | Recommended viewing range |
|---|---|
| 22 | 3.0′-9.0′ (0.9-2.7 m) |
| 26 | 3.5′-10.5′ (1.0-3.1 m) |
| 32 | 4.0′-13.0′ (1.2-4.0 m) |
| 37 | 4.5′-15.0′ (1.3-4.6 m) |
| 40 | 5.0′-16.5′ (1.5-5.0 m) |
| 42 | 5.5′-17.5′ (1.6-5.3 m) |
| 46 | 6.0′-19.0′ (1.8-5.8 m) |
| 52 | 6.5′-21.5′ (1.9-6.5 m) |

In embodiments of the present invention, if there is any deviation from the recommended viewer distance, the presentation size can be recalculated. For example, if the viewer has a 52″ display surface with a resolution of 1920×1080 pixels and the viewer is closer than 6.5° from the screen, the UI size can be decreased and if he is further than 21.5° from the screen, the UI size can be increased. Other use cases include: on a larger display surface, more options from a VOD catalog menu can be displayed, but if the viewer is too close to the display surface, fewer options can be displayed; on a larger display surface, the size of subtitle text can be increased; etc.

The solution can be integrated into the middleware of the client device as an independent component.

If the content were defined in HTML and rendered using a browser rendering engine, then such a re-render could be achieved by appropriate use of scaling and text size styles.

By way of a further example, at a viewing distance of 5 m, the system may determine that the minimum physical text size for good legibility is 2 cm, which with a display surface resolution of 15 pixels/cm results in the text glyphs being rendered at a height of 30 pixels. When an EPG grid is scaled for presentation at the desired size, the text glyphs are smaller than 2 cm/30 pixels, hence either the EPG grid is scaled so that the minimum 2 cm height text is maintained, with the whole EPG grid taking up more space on the display surface than desired, or the EPG grid is re-rendered to fit the target area of the display surface, but with fewer text items at the 2 cm height.

Where the system can identify individual viewers, each viewer could undergo a simple on-screen testing procedure on first use of the system to establish a personal visual acuity (similar to a letter height eye-chart used as the basis of an eye test), rather than assuming an average or default value.

Increasingly, various different versions of an item of content (e.g. SD and HD) are simulcast, but it is also possible to produce many different resolution and quality versions of the content available either using spatial or SNR scalable coding, or through provision of multiple bit rate or resolution ABR streams. Moreover, it is bandwidth inefficient to use high quality, high resolution, high bit rate versions of content when it is not necessary, for example when the content is being presented at a small size, or when the viewer is at a large distance from the screen, or when the viewer is not deeply engaged/immersed in the content (for example, because the large display surface is primarily being used for another task).

According to embodiments of the present invention, an appropriate resolution for content can be selected based on viewing distance, size of presentation and engagement level, whereby these factors are used to determine a level of detail which can be used to determine which level of a spatially scalable coded video is to be used or which bit rate of an ABR stream is to be used, such that a high quality visual experience is maintained.

A knowledge of viewing distance, size of presentation and engagement level enables the calculation of an appropriate bit rate or scale size, for example as follows:

The inputs can be converted to a point score indicating the scale size or bit rate quality:
Screen size:
   Smaller than 24 inches=0 points
   Between 24-40 inches=5 points
   Greater than 40 inches=10 points
Distance from the screen (based on recommended viewing range as described above):
   Closer than recommended=0 points
   Recommended=5 points
   Further than recommended=10 points
Viewer engagement:
   Not in the room=0 points
   Watching but channel hopping/zapping=5 points
   Very engaged=10 points

A high bit rate or scale size is typically used when the viewer is engaged with the content AND the screen resolution is high AND the viewer is not too close to the screen (e.g. 30 points). A low bit rate or scale size is typically be used when the viewer is not engaged with the content OR the screen resolution is low OR the user is too close to the screen (e.g. one of the input points scores is zero points).

Motion detection may also alter the calculation, e.g. if a viewer is watching a video on train, bus, other form of transport, or walking a high quality video is probably not required.

Standard quality video can be used when the user reaches between 10-20 points from any combination of input scores.

The bit rate or scale size is typically recalculated frequently to acquire appropriately content for the viewer at each moment.

If one of the inputs is not available at any given time, the algorithm is still typically used using the available input scores.

The bit rate or scalable size typically ranges from SD video to Ultra HD.

In alternative embodiments, if the size and resolution of the display surface and the desired presentation size on that display surface are known, then a minimum resolution so that no upsampling is required can be determined, and content of an appropriate resolution can be selected. If the presentation size changes or is dynamic, then the same procedure can be used to determine if there is a more appropriate resolution of the content, possibly on a continuing basis.

These models can be further refined, if the viewing distance of the viewer is known, together with a value (either known or estimated) of their visual acuity. Visual acuity is a measure of a viewer's ability to see or resolve detail (see http://en.wikipedia.org/wiki/Visual_acuity). Given knowledge of viewing distance and the viewer's visual acuity, the system can determine:
Whether the user is capable of resolving individual pixels of the display surface itself. If the viewer is capable, then content can be selected and presented as previously described, i.e. such that no upsampling is used;
If the viewer is unable to resolve individual pixels, there is the potential to use a lower resolution version of the content and upsample it, because there is no point showing detail that cannot be perceived by the viewer at their viewing distance. The intended presentation size is combined with the size of resolvable detail at their viewing distance to determine the minimum resolution of the content for presentation;
A measure of viewer engagement/immersion could also be incorporated such that if a viewer is not paying much attention to the content, for example if the content is not the primary on-screen activity or content (or indeed, if the system detects the viewer has left the room for a period of time), the system can select lower resolution content and upsample it;
A model of viewer visual acuity can also be used to estimate how visible coding artifacts would appear to a viewer, and in scenarios where multiple bit rate encodings of the content are available, can be used to determine the lowest bit rate encoding that can be used without the artifacts adversely impacting the viewing experience.

A user's level of engagement/immersion can be determined and used to adapt the presentation of content. It is to be noted that some specific signals that indicate user engagement are content-specific, e.g. an engaged user may be physically active and vocal during an exciting sports match, whilst relatively still and quiet during a movie. As such, a number of the following signals are typically evaluated together in the context of the currently viewed content (e.g. using content metadata as described above):
An analysis of the audio in viewing environment 101 (typically audio not caused by the presentation of content) can be used to determine whether a viewer(s) is (are) talking, and whether this discussion is about the viewed content or not. This could include: using speech recognition to determine whether any of a set of keywords that are known to be relevant to the presented content have been uttered (such keywords could be explicitly authored and delivered, or could be derived from available content metadata), or analysis of in-room audio levels at signaled points in the content (these points would typically be created editorially by the content creator) that are likely to elicit a viewer reaction, for example key points within a sports match (e.g. goals scored, fouls committed, etc.), moments of suspense/surprise within a horror movie, chase sequences within an action movie etc.
Position of a viewer(s) in the room (e.g. the closer they are to the screen, the greater the likelihood of engagement; etc.)
Direction of gaze of a viewer(s) (e.g. are their eyes open; are they looking at the screen most of the time; etc.)
Degree of movement of a viewer(s) over time (e.g. are they animated or likely to be asleep; etc.)
Remote control usage (e.g. is the user holding the remote (detectable, for example, by use of an accelerometer in the remote control); has a remote control button been pressed recently; etc.)
Past user history (e.g. by using a history of previously viewed content, it may be possible to predict whether the currently presented content item is likely to be of interest/engaging to the viewer; etc.)
Nature of the content (e.g. a user may be assumed to be more immersed/engaged in certain content which is played back rather than watched live; a user may be assumed to be less immersed/engaged in content which is broadcast early in the morning and more immersed/engaged in content broadcast during primetime viewing; etc.)
User behaviour (e.g. is the user engaging in intense channel zapping/hopping; is the user using trick modes to navigate through the content and/or advertisements; etc.)
User interaction with other devices such as companion device 137 (e.g. is the user heavily active on a personal device (typically detectable via network traffic to such a personal device, or through information made available via such a personal device.)

The presentation of content can then be adapted in dependence on the level of immersion/engagement, for example:
If the engagement is low, the video size and audio level can be reduced; alternative viewing choices could be presented to the viewer; etc.
If recorded content is being played back, or being viewed on-demand, the presentation speed can be varied to move more quickly through less immersive/interesting/engaging portions of the content;
When users leave the viewing environment, the system can automatically increase the volume and appropriately balance the sound (within sensible limits) so the users can still hear the audio in the content when they have left the viewing environment (e.g. to support an open plan living environment where some ‘contact’ with the content is possible/expected outside the immediate viewing environment);
Apart from determining which additional content elements might be shown, immersion level can also be reflected in the audio presentation (volume level and dynamic range), and through control of other environmental factors, such as lighting levels;
Immersion level may also change a viewer's tolerance for interruption (e.g. when a user is fully immersed then there may be relatively few interruption sources that should be presented immediately (e.g. the baby monitor audio exceeding a threshold; audio or video calls from close family; etc.) The system could maintain an ‘interrupt mask’ (or interrupt threshold) that maps to immersion level, so that only appropriate interruptions sources interrupt the viewing experience (e.g. lower priority interruptions will be presented to users, but presentation may be delayed to a point where immersion level is naturally reduced, for example at the end of the movie, or during an advertisement/commercial break, or presentation might be in a more subtle, less intrusive manner, for example using a small icon).
Presentation of the content may need to be adapted to be optimally presented on a particular display surface. For example:
   Since a display surface could cover a substantial part of, or an entire wall, different viewers may have display surfaces with large variations in size and/or aspect ratio. The layout of content on the surface preferably takes advantage of the available space.
   Display surfaces enabled by thin or no-bezel tile-able panel technology, or high-resolution projectors, which could cover a substantial part of, or an entire wall, have the potential to blend seamlessly into the environment by displaying a pattern matching that of the surrounding walls (‘virtual wallpaper’), with other content overlaid or composited onto this default pattern appearing to be rendered directly on the wall. Different viewers will typically have different ‘virtual wallpaper’ with particular patterns and colours. In certain embodiments, the rendering of content (e.g. text or graphics) takes into account the colours and/or patterns in the ‘virtual wallpaper’ background so that complimentary or contrasting colours can be used to improve legibility of the content, or to avoid a badly clashing colour scheme. Alternatively, if the content is close in colour to that in the wallpaper, it could be rendered using a drop shadow, or over a region of a contrasting colour to improve legibility.

Acoustic and lighting properties of viewing environment 101 can be determined and used to adapt the presentation of content, i.e. given that the system has visual & audio sensors, or may include one or more companion devices having sensors that can monitor the viewing environment, the system can monitor:
How much background noise is there in the viewing environment (e.g. from domestic appliances, etc.), and how this varies over time. Properties such as the audio level, audio dynamic range etc. can then be adjusted to be appropriate to the background noise in the viewing environment
How much ambient light is there in the viewing environment and how this varies over time. Properties such as the picture brightness and colour balance can then be adjusted appropriate to the level of ambient light in the viewing environment
In a system where a display surface is showing content overlaid onto ‘virtual wallpaper’, changing the ambient light level will typically change the perceived appearance (e.g. brightness, saturation, colour temperature) of the real walls in the room, and when this happens the system can automatically adjust the presentation of the ‘virtual wallpaper’ to maintain a match, without effecting the presentation of other content (e.g. video) on the display surface. The previously described visual sensors can be used by the system to maintain a visual balance between real and ‘virtual wallpaper’ in dynamically changing ambient lighting conditions in response to viewer immersion
Whether there is an audio resonance at specific frequencies due to the nature of viewing environment 101 and the position of speakers within it. The system could then apply a compensating equalization to the output audio.

Typically, users may also modify the content presentation according to their own personal preferences and may also explicitly set their level of engagement for example, by controlling a slider on a connected companion device, using dedicated remote control buttons, through explicit spoken commands to a speech recognition system, or gestures to a gesture-based system. Moreover, users may also define content presentation preferences for given levels of engagement.

Typically, the system is also able to identify user specific content or user generated content and then to adapt presentation of that content (e.g. presenting the content in the most appropriate location, be it on the main display surface, a secondary surface, or on a personal companion device.)

It will be recalled that the system can control the visual presentation of content (e.g. size, position, brightness, colour balance etc.); audio presentation of content (e.g. audio level, audio dynamic range, audio position, audio balance, etc.); and other home devices (e.g. lighting levels, window blinds, etc.) in a variable viewing environment, that is, one where shared Surface(s), or personal or shared companion devices can be added to or removed from the viewing environment on an ad-hoc basis. Further details will now be provided below.

A problem exists in trying to automatically detect the relative spatial location and position of multiple display surfaces that might be connected to the same layout manager. The display surfaces may be of different sizes or types, and their positioning could be arbitrary, and possibly non-planar. Currently, within the computing domain (where PCs and laptops can support multiple displays through multiple display outputs, and a virtual desktop that spans these displays), the user manually configures the system in order to tell the operating system where the display devices are in relation to each other.

It will be remembered that according to embodiments of the present invention, the client device is in operative association with sensors 133/135 that may include a camera. The camera may be setup to face towards the display surfaces, such that all of the display surfaces connected to the client device fall within the field of view of the camera.

The layout manager typically maintains a map of the physical locations and orientations of the display surfaces connected to the renderers.

On start-up, and subsequently whenever the layout manager detects the connection of new display surface renderers, the client device outputs a unique, readily recognizable image to the newly connected display surface renderer. The layout manager uses the signal from the camera to identify the position and orientation (i.e. rotation) of the image, and can use the identified position and orientation of the image to update its surface map.

If the axis of the camera is not normal (i.e. perpendicular) to the display surfaces, then the images within the camera signal are typically subjected to a projective transformation.

Differing projective transformations of each image can give an indication of non-planar display surfaces. If the system is aware of the position that the display surface(s) is (are) viewed from, it could perspective correct (by determining and applying a compensating projective transform) the displayed images on the non-planar screens. More details are provided below.

Where the layout manager identifies that display surfaces are adjacent, it may offer the user the capability to scale presented content across these adjacent display surfaces. It may still use non-adjacent display surfaces to show other applications or content, or application or content related to that on other display surfaces.

The layout manager can also use the surface map to work out how to matrix (mix) the content audio between all of the available speakers associated with each of the display surfaces; for example if there were two adjacent display surfaces each with stereo speakers, and the content has 5.1 surround sound audio, the client device could map the front left channel to the left speaker of the left display, the front right channel to the right speaker of the right display, and the centre dialogue channel to the right speaker of the left display and the left speaker of the right display, all at appropriate levels.

The camera can also be used for additional functions, such as: calibrating the display surfaces such that the display characteristics are well matched (for example adjusting brightness, black level & colour temperature); if calibration is not possible, compensating the output so that the content is visually well matched across the different display surfaces; identifying timing discrepancies due to different latencies in each display surface, and introducing compensating delays in the video outputs so that presentation across all surfaces is well synchronized; etc.

It is to be appreciated that tile-able display surfaces (as previously described) might be re-configurable by users, i.e. one or more tiles could be added to an existing display surface to make it bigger, or removed to provide a smaller second display surface to be used for another purpose (viewing content on a users' lap, or to take into another room/viewing environment), but still leaving the original display surface usable (albeit smaller).

A problem arises for the layout manager that is managing content across the display surfaces: that is, how can the client device determine the relative locations of tiles in such tile-able display surfaces, and then adapt content presentation to dynamic configuration changes.

According to embodiments of the present invention, the system comprises: multiple tile-able display surfaces (or ‘tiles’) that can be arranged to form one or more larger display surface groups; a layout manager managing content layout across each of surface groups, and one or more renderers each driving one or more display tiles, in response to the layout engine. Each of the tiles might additionally have speakers; have a battery to enable portable use; have orientation sensors; and support touch interaction by users.

The layout engine typically has a bidirectional connection to each renderer, which in turn has a bi-directional connection to each of the tiles it drives, which would typically be wireless to ease dynamic re-configuration (e.g. WirelessHD, WiGig, WHDI, etc.)

Each renderer is able to discover it's connected uniquely addressable tiles through a suitable protocol, and request that each tile in turn report the identity of its neighbor(s) (for a rectangular or square display tile, there would be up to four neighbors, which could be described as cardinal points e.g. North, East, South, West).

Once the renderers have acquired this ‘neighbor’ information, it can report it back to the layout manager, which will construct a ‘map’ of the relative location and orientation of each tile within a larger display surface group, and the overall boundary of each surface group. The layout manager can then manage the overall layout so that the appropriate content (video, graphics (e.g. an EPG or interactive application)), audio, etc.) is rendered on each surface group, which each renderer rendering the correct content for each individual tile, and that rendered pixels/audio samples are sent to the correct tile for display.

If the tiles have speakers, then audio channels could be matrixed (routed) to specific edges or positions in the panel; for example if there were two tiles in a group with stereo speakers, and the content has 5.1 surround sound audio, it could map the front left channel to the left speaker of the left tile, the front right channel to the right speaker of the right tile, and the centre dialogue channel to the right speaker of the left tile and the left speaker of the right tile, at appropriate levels.

When a user separates, joins or re-orientates display tiles or groups of tiles, the tiles concerned report this to the renderer, reporting back to the layout engine, which will update its surface tile map. It will then adapt its layout appropriately.

Assuming that one or more content items is being rendered into rectangular regions within a display group (which is a typical content rendering model corresponding to windows on a desktop, or applications, EPG and video on a STB), then the following model can be used to determine what happens when a display surface group is split:
If a single content item (e.g. video, EPG, interactive application) is being shown full screen on the original display surface group, then on separation, the same content is presented on both display surface groups and rendered full-screen on each (or as close to full screen as possible). Since the content and display aspect ratios may not match, a 90 degree rotation may be appropriate if the new display surface group that is taken away is re-orientated.
If multiple content items are arranged on the original display surface group, then on separation for each item:
   If the item resides substantially on one side of the split then it will maintain its original position on a single display surface group after the split.
   If the item straddles the split, then it is ‘cloned’ onto both display surface groups.

In either of these latter cases, a re-layout of content on each of the new display surface groups may be appropriate to make best use of the available display surface area (either automatically, or user initiated)

The re-layout process referred to above would typically involve arranging the regions of each of the visible content items within the display surface group, such that:
The size of each is maximized (subject to any constraints e.g. maximum size for video, minimum size for a text based application to maintain legibility)
Free space is minimized
There are no content region overlaps

The layout algorithm may also be given a relative priority for the items (e.g. video to be presented largest, then a subtitle region etc.).

The user may be able to arrange the content regions directly on a display surface group prior to, or post separation (for example, if the tiles have a touch based interface).

Alternatively, the behavior as to whether to the content is mapped to a single or both display surface groups could be pre-determined (e.g. according to a declared user preference, for example, always clone all content onto both display screen groups).

When two display surface groups are joined, then a default behavior might be ‘no screen re-layout’ (unless one of the display screen groups has been re-orientated on joining). If the joined display surface groups are showing identical content items, then each of these this could be merged together into single instances, potentially displayed in a larger region on the new larger display surface group.

For tiles with speakers, audio channels are typically appropriately remapped on configuration changes.

When tiles are joined, the layout manager and renderers can also match any display settings across all of the tiles to avoid any visual differences between tiles in the display surface group, for example, brightness, contrast, etc.

The system also typically responds to external inputs (e.g. domotic video feeds, baby monitors, telephone, instant messaging, social networking and news feeds, discussion forums, images, etc.), determines an appropriate method of displaying the information related to such an external input, and adapts the presentation of content playing when such an external input is received in dependence on the user's level of immersion/engagement and interactivity.

As well as being used to control the immersion level, and hence adapt the presentation of content, companion device 137 also enable interaction with content presented on the display surface. For example, companion device 137 may show a ‘mimic’ representation of content as arranged on the surface, with the layout information to enable this mimic representation conveyed over a suitable connection from the display surface, for example the web-socket protocol running over a WiFi connection. Included in that layout information may be links to internet content, which when selected (by touching, clicking, otherwise interacting with companion device 137, etc.), would present the linked internet content in a browser or other suitable application also running on companion device 137. As an example, on a display surface, news headlines could be presented next to the news programme video. Representations of these headlines mimicked on the companion device 137 could be selected, with a link to the relevant online news story being presented in a browser. Such links could also include links to interactive applications such as voting and rating, social networking sites and pages for TV programmes, commercial sites offering promoted items for purchase etc. Such a model also allows multiple users to have parallel, but individual interaction with content on the display surface; each through their own companion device. Alternatively, an augmented reality application running on companion device 137 could be used to overlay links to internet content when the companion device is pointed at the surface.

The viewer(s) can also make use of the companion device(s) to modify the presentation of components of the content. For instance, the companion device(s) can be used to delete unwanted components of the content, or to re-arrange the presented content in a fashion the viewer(s) find preferable. These actions typically generate messages sent to the layout manager, which takes the appropriate action, modifying the layout accordingly. In this case, the layout manager may choose to remember these alterations, and reflect them when the same content is displayed in future.

In certain embodiments of the present invention, the system operates by defining a set of presentation maps. A presentation map comprises a list of content components/elements and presentation settings that describes, for example:
The (preferred) position & size of particular visual content elements on screen (including whether those visual content elements are displayed at all), including: AV content; other content that is contextually relevant to the presented content; content that may have no contextual relevance to the presented content but that the user wants to be available (e.g. information & social networking feeds, domotic content, etc.); content that may be requested by the user etc.
The volume, dynamic range & position of audio sources;
Other controllable environmental parameters e.g. lighting levels, window blind status;
Response reaction and presentation changes in response to domotic (and other) inputs unconnected with the primary content source;
Preferred destinations (e.g. main surface, secondary surface (see below), (personal) companion device, etc.) for components of the presentation.

Each item of content is typically associated with a presentation map, and each presentation map typically has presentation settings defined for different user levels of immersion/engagement appropriate to the content item. This is shown in FIG. 5. It is also possible for a single presentation map to be referenced by multiple items of content.

A component of the client device referred to as the layout manager determines which single presentation map is active at any point in time. A number of possible inputs are continuously evaluated by the layout manager to determine which presentation map is active. Such inputs include, but are not limited to: content; content genre; user; time of day; display surfaces configuration; user immersion/engagement level; user preferences; user input; arrival/departure of viewers etc. as described above.

Once a presentation map is active, layout manager uses a scalar variable i, representing the immersion level of the viewer(s), to determine which particular presentation settings are to be used. Variable i is typically continually re-evaluated and changes according to:
Existing & presentation-specific authored content metadata;
The detected level of immersion of the viewer(s) in viewing environment 101 (e.g. by head position and location, sound levels, keywords detected in speech, etc. as described previously);
Learned user preferences (e.g. by observing that when a given presentation map is active, a particular user tends to always use the same settings);
Direct user input (e.g. remote i+/i− buttons that allow the user to explicitly define their level of immersion/engagement; a slider (as described previously); or calling up a guide, which may force i to an appropriate level which includes presentation of a guide; etc.);
Time of day (e.g. engagement levels for late evening viewing may typically be higher than for early evening viewing, etc.)
Arrival or departure of viewers; etc.

FIG. 6 shows some example screen layouts corresponding to a series of presentation maps, and shows how the size and position of visible, on-screen panels change with immersion level, i where i=0 represents a zero or very low level of immersion and where the level of immersion/engagement with the presented video content increases with increasing i.

The layout manager typically makes smooth transitions (e.g. animations) as changes in i change the presentation settings, or when changing presentation map. When the system is used with surfaces constructed from multiple, contiguous, tile-able display screens where each screen has a bezel around its edge, the layout manager typically makes adjustments in the actual position of on-screen content so that content does not unnecessarily straddle any bezels.

In an alternative embodiment, the layout manager works dynamically with one or more simple presentation maps, where instead of specifying the explicit size and position of each on-screen panel for all given immersion levels, only a minimum size and desired location (top, left, right, bottom, centre) are specified. Each simple presentation map contains the on-screen panels for a particular user of the system. In the present embodiment, the layout algorithm then typically works as follows:

1. Panels are sorted into a list so that more important panels are at the start of a list and less important panels are at the end of the list.

2. The first panel is placed in its desired location. The desired location is specified in terms of top, bottom, left, right or centre.

3. Unused area of the screen is then sought and found.

4. An attempt is made to place the next panel on the list above, below, to the left or to the right of the first panel. For each position that has sufficient unused area, place the panel.

5. Recursively repeat steps 3 and 4 for each panel on the list, in every possible position.

6. At every step of the recursion, add the panel layout to a list of layout candidates, discarding duplicates.

7. At the end of the recursion, there is typically a list of possible ways to lay out the panels (layout candidates). It will be realised that some of the layout candidates will not contain all the panels, because there was insufficient free area for them to be placed.

8. Each layout candidate is given a score. Typically, the score is influenced by whether a panel is present in the candidate layout; whether panels are in horizontal or vertical lines; whether a panel that is a “child” of another panel is close to its parent (e.g. subtitles are a child panel of the video panel for the video to which the subtitles pertain); etc.

9. The layout candidate with the highest score is chosen as the layout.

When there are multiple users of the system, the previously described layout algorithm can be used to assign areas of the screen to each user. The layout algorithm is used to assign an area of the screen for each user and the layout algorithm is repeated, placing each user panel inside the area of screen assigned to that user. This approach has the advantage of allowing the same dynamic immersion based layout algorithm to adapt between the interests of an individual user and between the relative priority of users.

Those skilled in the art will realise that other functionally equivalent algorithms are possible.

FIG. 7 shows an example set of scored layouts generated by this algorithm. The various panels that the algorithm has attempted to place are: V—video content; S—subtitles to the video content; T—a Twitter feed related to the video content; W—web page related to the video content; F—Facebook news feed of the viewer of the video content.

This alternative layout manager implementation is advantageous in that it is able to accommodate an arbitrary number of panels that, for example, could arise if two users were sharing the display surface to watch two different items of content, each with their own presentation map; or to allow users to add their own preferred panels that are unrelated to the main content item. The system can manage and rationalise content items when duplicates occur due to multiple active presentation maps (e.g. by merging duplicate content items).

In a further refinement of this layout algorithm, panels that are logically related (for example, of the same type, owned by the same user, or contextually related e.g. video+headlines+subtitles) are grouped together into a sub-list, and the previously described algorithm then lays out panels in this sub-list into a region of the display surface. Multiple sub-lists, each with its own associated non-overlapping region on the surface can co-exist. This results in an overall layout that can be more intuitive to a user, since related items are spatially closer to one another. The layout manager manages the relative size and position of these sub-regions according to a simple algorithm that partitions the overall area of the display surface(s) depending on the number of sub-lists that are operative.

Those skilled in the art will appreciate that numerous other factors could be included in the information that is used in the layout algorithm to both place panels and score the layouts. These include, but are not limited to: preferred relative positioning of panels or sub-lists (e.g. left, right, above, or below), alignments between panels or sub-lists (e.g. centre or edge), desired separations or margins between panels or sub-lists, absence of separations or margins between panels or sub-lists, etc.

In a further refinement of the system, the system can accommodate multiple display surfaces in a single environment (for example, on different walls in a living room), or in distinct environments (for example, different rooms of a house).

FIG. 8 shows how the architecture of FIG. 4 evolves to support multiple display surfaces. There is still a single instance of layout manager 403 that manages the layout of content across multiple, typically discontinuous, surfaces. The layout manager 403 is aware of the size, resolution (pixel density i.e. number of pixels per unit length or area) and relative position of each of the surfaces in the viewing environment, and manages how content is placed and, where appropriate, moved between the surfaces. Knowing the relative position of each of the surfaces enables the layout manager 403 to move content with realistic motion and/or ballistics even when those surfaces are discontinuous. Knowing the resolution of the surface also allows the layout manager 403 to accommodate surfaces that have a different resolution (perhaps, for example, as they use a different display technology or are just made by a different manufacturer). In a single surface implementation, it is typically acceptable for the layout manager 403 to use pixel units and co-ordinates for layout, but for surfaces of different resolutions, this could result in unintended scaling of content as it moves between surfaces. In this situation, the layout manager 403 typically adopts physical units for layout, which can be resolved into pixel units for the specific surface the physical units apply to.

According to embodiments of the present invention, multiple surface renderers are used to render content onto the various display surfaces. For example, primary surface renderer 805 renders content onto display surface 806 (under control of layout manager 403) while secondary surface renderer 807 renders content onto display surface 808 (also under control of layout manager 403). In some embodiments, two or more surface renderers (809/811) can each render content onto a single display surface 810. The layout manager 403 and each of the surface renderers could be hosted on different physical devices in a number of different permutations; for example, the layout manager 403 and primary surface renderer 805 could be hosted on a single client device, with the other surface renderers (807/809/811) each hosted on further devices. Alternatively, the layout manager 403 could be hosted in a home gateway, or even in the cloud, with each renderer (805/807/809/811) having its own client device. In alternative embodiments, a renderer may be integrated into the display device(s) comprising each display surface. In the multi-surface architecture, AV and graphics presentation on multiple surfaces is synchronised using a sync server 813 in operative communication with layout manager 403. The operation of sync server 813 will be described in more detail below. Again, this could be hosted in one of the client devices, or the gateway, or in the cloud.

It will be appreciated that in such a multi-surface environment (where multiple, independent renderers, running on independent hardware where each render is driving one or more displays that combine to build the overall surfaces), there may be a number of scenarios where the presentation of AV and graphical content on different surfaces is temporally synchronised, for example, when moving AV from one surface to another without discontinuity in audio or video, showing ‘multi-angle’ AV content (e.g. a concert or a sports event), where the video feeds are distributed over multiple display surfaces etc. There is typically also a single audio system in such an environment, which would typically be connected to one of the surface client devices (as such a system would typically not be able to ‘transform’ the position of audio feeds from the two different surfaces to reflect their actual positions). Thus when video is displayed on other surfaces, the audio is typically decoded on the surface connected to the audio control system, and hence AV synchronisation between these surfaces is desirable.

The synchronisation between display surfaces typically covers:
The same video decoded over two (or more) renderers;
The video decoded on one or more renderers with the audio on a different renderer;
Graphical animations moving objects between and over renderers;
Graphical frame rates between different renderers (under different loads—for most graphics systems (whether GPU or CPU based), a different workload (i.e. amount of graphics to process) affects the time it takes to generate a given output frame. Thus differing loads between renderers (or processing power between renderers) may well result in differing output frame rates); and
Synchronisation between graphics on one or more renderers and video on another renderer (or renderers).

The result is typically that the behaviour of two renderers connected to two display surfaces is identical, when viewed as if it was one renderer driving one display surface.

Synchronisation refers either to synchronisation of a clock between devices (i.e. the time something happens), or synchronisation to a given processing point (progress though an algorithm) between devices. However these types of synchronisation are not necessarily sufficient for all use cases, specifically those involving graphics. In the area of graphics, the state used for the generation of the frame is typically agreed in advance. A simple example of this is where the graphics represent the movement of an object. For all renderers to co-operate they typically agree on the state, i.e. position, of the object that they are rendering, for each frame that they render the object. This is unlike video where (assuming the same input frame is being decoded) the same output is always generated by all decoding operations.

Two broad categories of approach for achieving the desired synchronisation are:
Synchronised clocks: all renderers have the same clock, and agree to do things (e.g. produce the next frame) at the same time; and
Barrier methods: renderers all wait for each other to reach a given point (e.g. prepare a frame), and progress (e.g. display the frame) when they all have reached that point.

Regarding synchronised clocks, one known mechanisms is the IETF standard Network Time Protocol (NTP) RFC 5905. This uses network messages to synchronise clocks between computers to a “global” wall clock, and under ideal conditions achieves less than 10 ms inaccuracy between machines. Clock synchronisation is also described in Chapter 10 of Distributed Systems Concepts and Design, by George Coulouris, Jean Dollimore, Tim Kindberg (2^{nd} edition, 1994). The Precision Time Protocol (PTP) (IEEE1588) is an extension of the NTP algorithm that uses specialised hardware extensions to timestamp packets allowing a greater accuracy of clock recovery. The MPEG-2 transport stream has a clock recover mechanism that, theoretically, allows renderers to synchronise to sub-millisecond accuracy. However, this relies on the receipt of clock samples from a (broadcast) network of very limited jitter and known latency. The practical nature of renderers on a home network is that the clock recovery will suffer from the jitter introduced on this network.

Barrier synchronisation is a known mechanism for synchronisation in computer science. Proposals (such as those in High-Performance Dynamic Graphics Streaming for Scalable Adaptive Graphics Environment by Jeong et al., SC2006 November 2006, Tampa, Fla., USA) work by having each renderer produce a new frame and block until all have that new frame ready for display, at which point each renderer releases that frame, and then goes on to produce the next frame.

Clock synchronisation mechanisms typically require agreement in advance of the time at which the next frame shall be released. Barrier synchronisation typically require messages between renderers for each released frame, and for certain operations agreement in advance of the time at which the frame should be targeted for display (so that animations know how far an item should move). As mentioned above, neither clock nor barrier synchronisation addresses all the issues with graphics. More specifically, they can address *when* to do something (e.g. display the frame) but they do not address *what* to display (i.e. the state to construct the frame).

FIG. 9 gives an abstract impression of what happens if the state is not synchronised. In this case, at every other frame the renderer driving Screen 2 fails to move the state on that represents the movement and rotation of the graphic object. (It is to be noted that this results in the same effect as if it was to be operating at a lower frame rate, which is a separate issue discussed in more detail below).

FIG. 10 shows the basic components of a synchronisation mechanism according to embodiments of the present invention. The mechanism applies to AV playback at normal speed, and “smooth” trick modes where the playback is made at a rate other than the normal playback rate, for example 1.5×, 2.5× or 15×. As mentioned previously, the mechanism aims to synchronise the video playback across numerous renderers.

The primary renderer 1001 (typically pre-selected as the primary renderer but other methods for selecting which renderer is designated as the primary renderer are possible) represents the ‘master’ to which other renderers are to be synchronised. The one or more secondary renderers 1003 represent ‘slave’ renderers that are synchronised to the ‘master’ renderer. Typically, these ‘slave’ renderers do not output audio (and hence the ‘master’ renderer is typically connected to the audio control system. A synchronisation (sync) server 813 (as mentioned previously) decouples interactions between the ‘master’ renderer and the ‘slave’ renderers, and minimises the changes to each.

According to embodiments of the present invention, the synchronisation mechanism operates as follows:

The master renderer 1001 sends its media time at audio output to sync server 813, and does this repeatedly. A slave renderer asks sync server 813 for the time of the master playback audio. The slave renderer uses this time to synchronise the audio playback, ensuring that the audio frame it is presenting to the (unused) slave renderer audio output matches the one that the master should be presenting, based on the time reported by the sync server 813. This process also syncs the media time in the slave renderer 1003 with the media time from the sync server 813, and hence from the master renderer 1001. The normal AV sync processes also ensure that the video is then synchronised between the master renderer and the slave renderers. Throughout this process, standard techniques are used by the sync server 813 to match clock rates with the master renderer and in the case of the slave renderers, the playback rate is modified to achieve this. For example, if a renderer was running slowly, the audio playback rate could be incremented appropriately so that, for instance, it might be playing back the unused audio at 1.05 times that indicated by its clock).

FIG. 11 is a time sequence diagram showing a logical view of the communications in the synchronisation solution described above. Three main entities are involved in the operation: the primary ‘Master’ renderer 1001, which is the renderer acting as the timing source; the sync server 813; and the secondary ‘slave’ renderer 1003, which is the renderer that is synchronising itself with the master renderer to achieve a consistent playback effect. The primary renderer 1001 comprises an audio driver 1101, audio renderer 1103 and a clock 1105. The secondary renderer 1003 comprises an audio driver 1107, audio renderer 1109 and a clock 1111.

The sequence starts with the primary audio driver 1101 (which has received data from an audio decoder (not shown)) sending this received data to the primary audio renderer 1103. The primary audio renderer 1103 calculates the time of the audio sample currently being played out (typically the renderer has a buffer to avoid audio glitches). It then sends the time to the local primary clock 1105, which then passes this time onto the sync server 813 (“Set time to Y”). On receipt of this time, the sync server 813 updates (if required) its copy of the master time and adjusts the clock rate if necessary.

Meanwhile, the secondary ‘slave’ renderer 1003 has also generated some audio data for which the secondary audio renderer 1109 has a time value based on the output sample it is playing, and it passes this time value to the local secondary clock 1111 (“Time Is”). Unlike the master clock 1105, the secondary clock 1111 asks the sync server 813 for the time (“Get Time”), to which the sync server 813 responds with its interpretation of the current master time (“time is Y+δ”). The secondary clock 1111 then compares these times, informs the secondary audio renderer 1109 of the timing error it currently has (“you are out by”), updates its own local copy of the master clock and corrects its clock rate. The secondary audio renderer 1109 then has the choice of blocking, jumping or altering playback speed as appropriate to maintain synchronisation.

The primary clock 1105 (as used by master renderer 1001) and the secondary clock 1111 (as used by the secondary renderer 1003) are also used by the video renderers, so the above method will inherently obtain video synchronisation, and as audio samples are used for calculations, the synchronisation should be more accurate than video samples since the audio sampling rate is typically c.48 kHz compared with a video sampling rate of 24 to 60 Hz.

The messages can be sent at a flexible rate. In the present embodiment, the time is updated (i.e. an exchange of messages with the sync server 813 takes place) when a prepared chunk of audio data is required for the output device (e.g. about every few hundred milliseconds), but this rate could be reduced or increased based on the monitored accuracy as noted by the sync server 813.

According to embodiments of the present invention, there are two options when a slave renderer notes that its clock is out of step (i.e. not synchronised) with the master renderer and when trick modes are not expected. It can either “jump” to the new correct value, or it can modify the speed at which it plays back its content to catch up with and then match the playback of the master renderer.

The mechanism described can also work where trick modes are used as it will simply modify the playback rates on the renderer as each slave renderer notes the changes in the master clock. However, if the renderer is aware of a standard set of playback rates that are available, this information can be used to modify the playback rates. For example, if the renderer knows that the normal playback rates include a 6× mode, and it detects a jump in the master renderer clock that matches that, it can move into a 6× mode.

As well as automatically identifying such rate changes, the system could arrange for messages to be sent to explicitly change the rate of playback. These messages could include additional conditions such as “and this will start at media time Y” to allow better synchronisation at the start of the trick mode.

For pause and seek/jump cases, a different mechanism is typically used as these represent “normal” operations. In both these cases, there is the option of either an explicit implementation (e.g. a message is received by the slave renderer indicating a seek has occurred) or an implicit implementation (e.g. the slave renderer or sync server detects a time change indicating a seek has occurred).

For an identified jump, the point in the content is advanced but the playback rate is not altered. For pause mechanisms, an explicit message is used in present embodiments. The sync server 813 can generate the explicit message, which typically includes a “pause at” component set very slightly into the future (e.g. one or two frames). In alternative embodiments, the sync server 813 can also send out a “pause now” message. In the case of a “pause now” message, the existing clock mechanisms can be used to identify any mismatch between the master and slave renderers, with the playback instantly adjusting as required.

As discussed above, for graphics the “Input state” e.g. target of what positions/location of objects to render are typically agreed, and the frame rates are typically matched. As FIG. 9 shows, both situations can result in mismatched frames.

Matching the frame rate can typically be achieved via a barrier on each frame, with all renderers blocking until all have generated a frame, and then progressing to the next frame. Where a video sync as described above is available, this can be used to provide a barrier, assuming that renderers can identify the target frame rate, and hence target output time. This can be done by targeting certain fixed rates (e.g. 30 fps, 60 fps, 15 fps). Where any renderer misses a frame rate target, a communication message, which can piggyback with the video synchronisation, indicates that all renderers are to drop to the next lowest (or a specified lower) rate. Where all renderers communicate that they are generating frames sufficiently quickly that the next fastest rate is possible, the sync server 813 can then identify this case, and communicate this to all the renderers, with a time point at which the change should take effect.

Related to this is the timed event, e.g. where an event is due to occur after a given time has elapsed. In the presence of a synchronising video, this can be used to mark the time point at which the event is to occur.

The embodiments described above have addressed synchronisation of video with video, or graphics with video. Another case is that of synchronising video with graphics, which is decomposed into two problems:
Starting a graphic or graphics animation at a specific time in the video; and
Maintaining synchronisation between a graphics animation and a video.

Examples of this are shown illustratively in FIG. 12. In stage (a), the video is playing showing a car; this video does not cover the entire display surface, though it could end at the edge of a screen or renderer. In stage (b), the car reaches the edge of the video. At this point a graphic animation is started to create a graphical version of the car. Stage (c) shows the situation a few frames later where the video has the car driving off the video, while maintaining the correct size and timing alignment with the video so that the car does not shrink or grow in length. This continues through stages (d) and (e) during which the synchronisation remains in place, and potentially spans another screen (as shown) and even another renderer. Finally when the rear of the car reaches the edge of the video, as shown in stage (g), the synchronisation can be broken or stopped.

The first problem mentioned above (that is stage (b)) can be solved via triggering the animation based on the video timeline. In the present embodiment, the trigger may be on a remote renderer (e.g. the graphics is to start on a different surface from the one containing the video). This can be handled by using a slaved, but invisible, video on the target renderer and then using the normal local time triggers, and relying on the video synchronisation described above to achieve the synchronisation. Alternatively, where network performance is adequate or synchronisation requirements are more relaxed, the local creation of any graphics item can be performed via a server (e.g. layout manager 403), which in turn informs the relevant renderer of the graphics to start.

The second problem (that is stages (c) through (e)) typically involves continual rate synchronisation and state synchronisation as described above. In this case, a continual update is used, and so a hidden video is typically present on all current renderer(s), and the graphics is then synchronised with the local video. This is done by using the current video frame rate (which is easily determined as needed by the sync server 813), and using this to set the state frame rate. The release of the graphical frames is then tied to the video by matching each graphical frame to the corresponding time of the video clock (easily calculable based on the known target starting time, the frame rate, and the number of elapsed frames) and having each renderer locally lock the graphical frame display to the decoding of a hidden or virtual video in order to provide a convenient reference.

In some embodiments, the layout manager 403 might inform every surface renderer about every change in size, position, volume, etc. of every item of content. However, when this communication is based upon point-to-point communication between the layout manager and each surface renderer, it is more efficient to only inform each surface renderer of the changes that directly impact the content that it is displaying or is about to display.

The layout manager 403 typically only considers content items in their abstract form as simple 2D polygons. The layout manager will typically have a 3D model of the locations and orientations of each surface, on to which it projects each abstract content polygon as part of its layout calculations. Each surface renderer is informed by the layout manager 403 where to place these content items and the surface renderer is responsible for translating this high level position description in to the appropriate media-specific transforms. For example, the layout manager 403 might decide to place a text panel at a particular position on a surface and the surface renderer of this surface deals with text font sizes, colours, etc. and flowing the text in to this panel. A video panel might have 2D scaling transforms applied by the surface renderer in response to a high level position description—this is an example of how a renderer can achieve a presentation as specified by the layout manager.

If there is presentation-specific authored content metadata, one of the surface renderers rendering the AV content is selected as a “timeline owner”. This “timeline owner” sends messages to the layout manager 403 when events occur in the AV stream. The layout manager 403 then reacts to these messages and possibly sends updates to one or more other surface renderers. For example, the subtitle data embedded in an AV stream might cause events to be triggered on the client device each time there is a change in the subtitles. These changes can be sent to the layout manager 403, which decides if there are any surfaces that are displaying the subtitles and then sends the appropriate updates to the relevant surface renderers. This allows for the subtitles to be displayed on a different surface (or companion device) from the surface that is rendering the AV.

There are a number of mechanisms by which the layout manager 403 may become aware of the size, resolution (pixel density i.e. number of pixels per unit length or area) and relative position of each of the surfaces in the viewing environment. This could be via:
Manual configuration;
Automatic Kinect-like devices (as described previously) analysing video or still images of the environment to generate the relevant information; or
Camera equipped companion devices (as described previously) that scan the environment and from that generate the relevant information.

In a system where the display surface is showing content overlaid onto ‘virtual wallpaper’, well known image analysis techniques (e.g. as provided by the Open Source Computer Vision Library “OpenCV” http://opencv.willowgarage.com/wiki/) can be performed on the underlying ‘virtual wallpaper’ in order to provide feature extraction such as edge detection and object detection. Proposed potential placements of visual content elements (i.e. components of content being presented such as video, images, graphics, text, etc.) may be assigned placement weighting (preference) influences based on the interaction of the content element with the extracted features, e.g. a placement with a minimum number of edge or object crossings is typically assigned a better weighting than a placement with a greater number of edge or object crossings. Placement of content elements can also be adjusted such that the placement aligns with detected vertical and/or horizontal edges. The size of the content element can also be scaled, typically within limits defined by properties associated with the content element(s). In certain embodiments, assistance/guidance information in the form of limits for automatic size manipulation can be provided.

The colour of any objects crossed by a content element (or close to a content element) can be identified (using the image analysis techniques previously mentioned) and then the colour properties of the content element can be modified to provide a clear visual separation between the content element and the object (e.g. by maximizing the ‘distance’ between the content element and the object on a colour space wheel). In certain embodiments, assistance/guidance information in the form of suggested levels for the minimum and/or maximum change of colour (e.g. ‘distance’ and ‘angle’ on a colour wheel) can be provided.

The general area that content element(s) are being placed into can also be analysed in order to identify a region, or regions of the ‘virtual wallpaper’ that the content element(s) may overlap. A predominant colour or set of colours for the region(s) can be identified. The colour of the content element(s) can then be adapted/modified to those predominant colour(s).

In certain embodiments, it may not be possible to adjust the placement and/or modify the properties of the content element(s). In such embodiments, a layer of graphics that isolates the content element(s) and provides a separation border between the ‘virtual wallpaper’ and the content element(s) can be inserted. The colour and/or transparency levels and the settings for the inserted separation border can be based on the underlying image analysis and/or the colour properties of the content element(s).

A method and system for viewing perspective correction according to embodiments of the present invention will now be described in more detail.

Content producers often produce content to be viewed in a particular way (i.e. at a particular distance perpendicular to the display surface. However, as has been mentioned above, a viewer will often not view the content as it was produced to be viewed (e.g. the display surface screen may be too large or too small, the viewer might view the content from a different height than the producer had intended, the viewer might view the content from a position that is not perpendicular to the display surface etc.

This latter case is depicted in FIG. 13 where a viewer 1301 is viewing content 1303 displayed on a display surface 1305 from a position that is not perpendicular to the display surface. A consequence of this is that the viewer's perception 1307 of what is being displayed appears distorted to the viewer 1301. Referring to FIG. 14, a solution to this problem, according to embodiments of the present invention, comprises transforming the displayed content to create the opposite distortion so that when viewed from a position that is not perpendicular to the display surface 1305, the perception 1407 of the distorted displayed content 1403 appears undistorted to the viewer 1301.

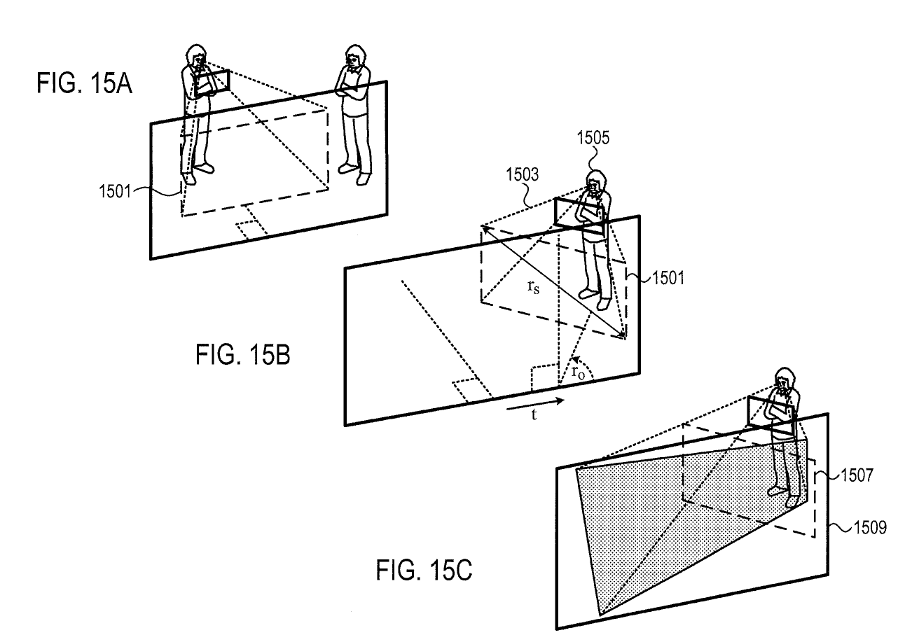

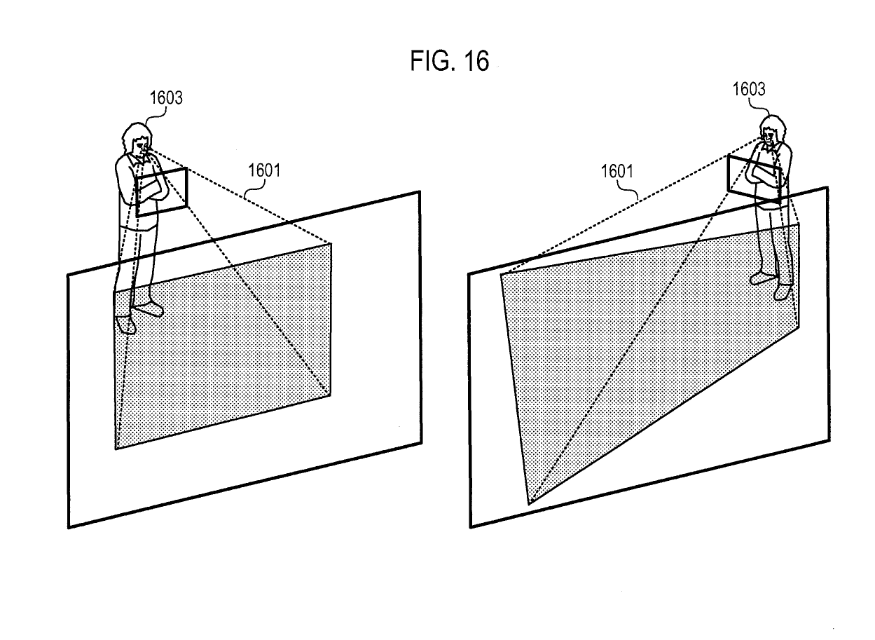

The solution according to embodiments of the present invention comprises three stages:
i. Referring to FIG. 15a, in the first stage, a three-dimensional (3D) display 1501 (i.e. a virtual screen which can be managed as a 3D object) is created from the original source content as it is expected to be viewed.
ii. Referring to FIG. 15b, the 3D display is then transformed (e.g. translated t, rotated rₒ, resized rₛ (as necessary)) to fit within the viewing cone 1503 of the viewer 1505 for the current position of the viewer 1505. (Referring to FIG. 16, a viewing cone 1601 defines the positions where the viewer's perception of the transformed content appears undistorted.)
iii. Referring to FIG. 15c, the transformed 3D display 1507 is then projected onto the display surface 1509.

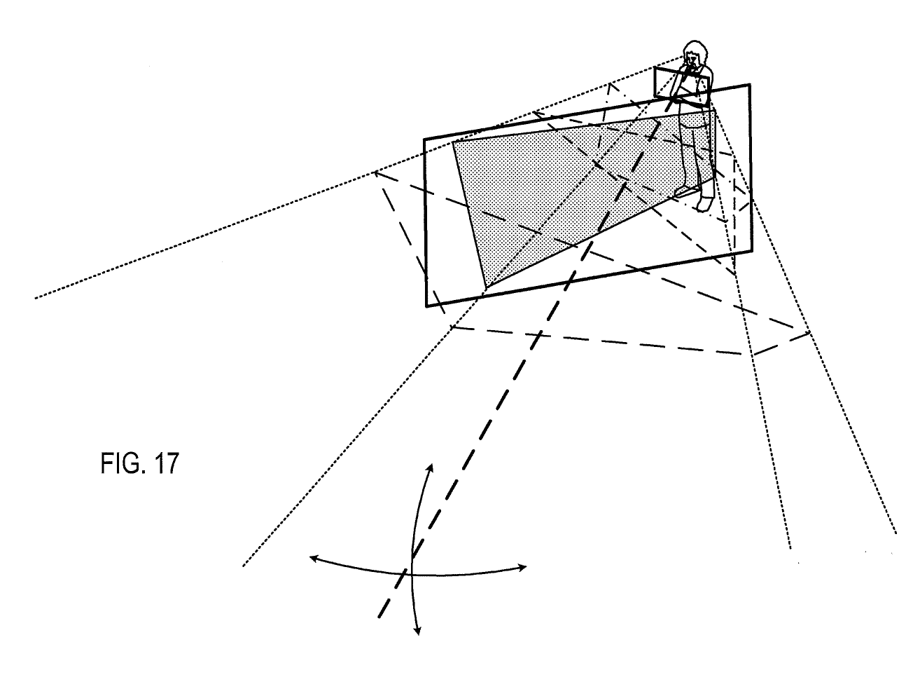

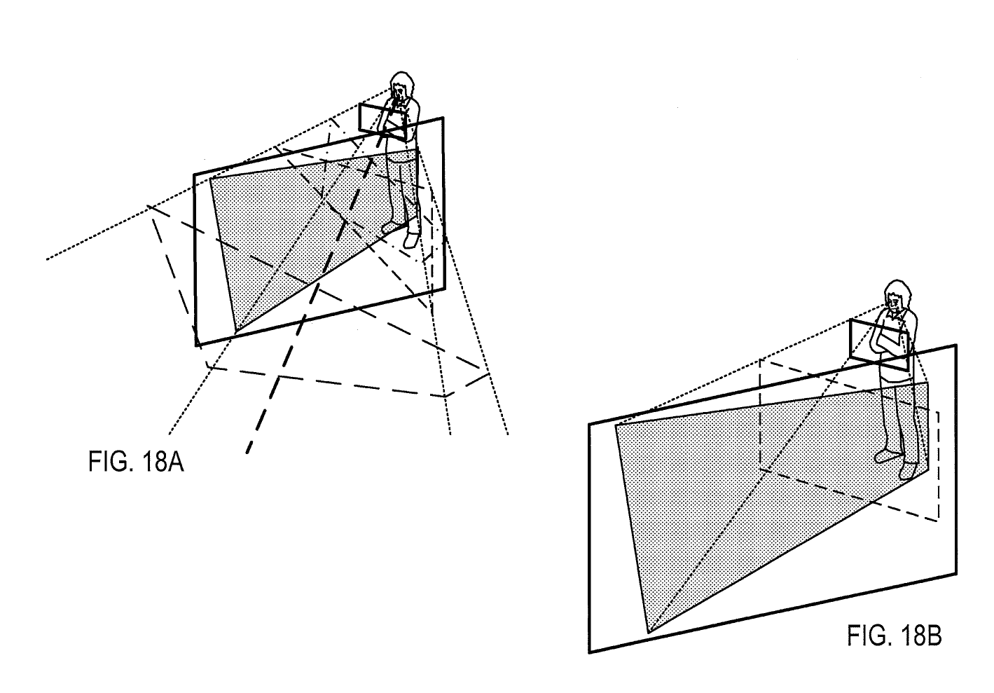

FIG. 17 depicts that undistorted perception of the content can be obtained by any linear transformation of the 3D object that hides the viewing cone in any direction before projection (i.e. any linear transformation that corresponds exactly to the viewing cone.) The result of the projection of any linear transformation of the 3D display that hides the viewing cone is always the same, i.e. the intersection of the viewing cone with the display surface. This is depicted in FIG. 18a. The choice of the transformation, therefore, has no impact on the viewer and is typically chosen so that the center of the base of the viewing cone intersects with the display surface (as depicted in FIG. 18b) and this is typically achieved by a combination of regular transformations such as rotation, translation and resizing.

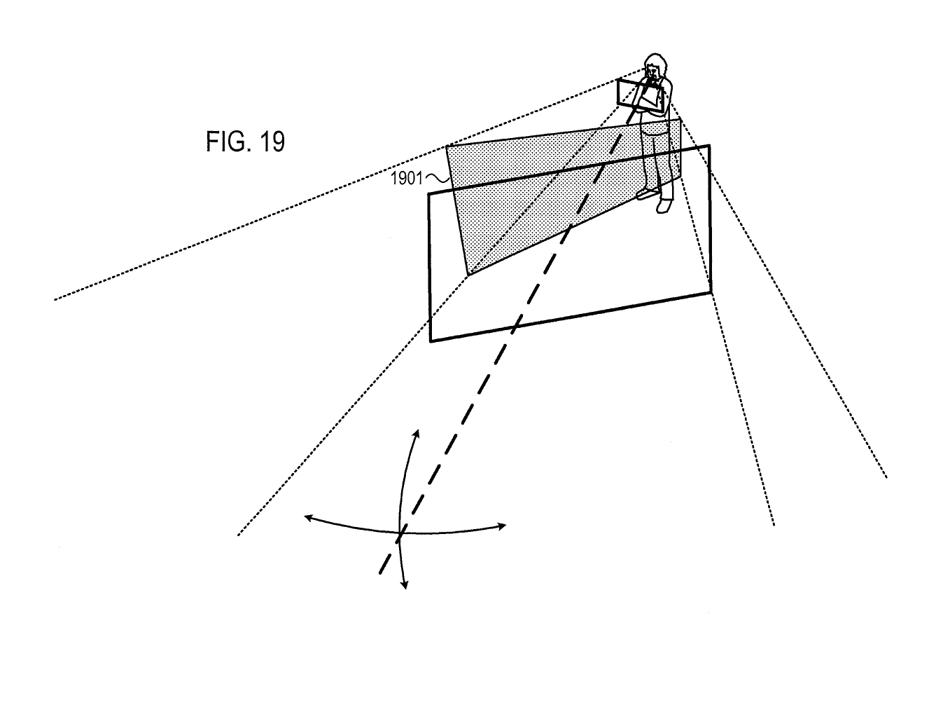

FIG. 19 depicts that the direction of the viewing cone defines the position of the projected transformed 3D display on the surface, which directly impacts the viewer as there are some directions that would hide (partially or perhaps totally) the projected display (e.g. portion 1901 is depicted as hidden). The appropriate direction for the projection is typically the one that causes the simplest transformation.

Two further concepts will now be introduced: the triangle of perpendicularity and the disc of conservation.

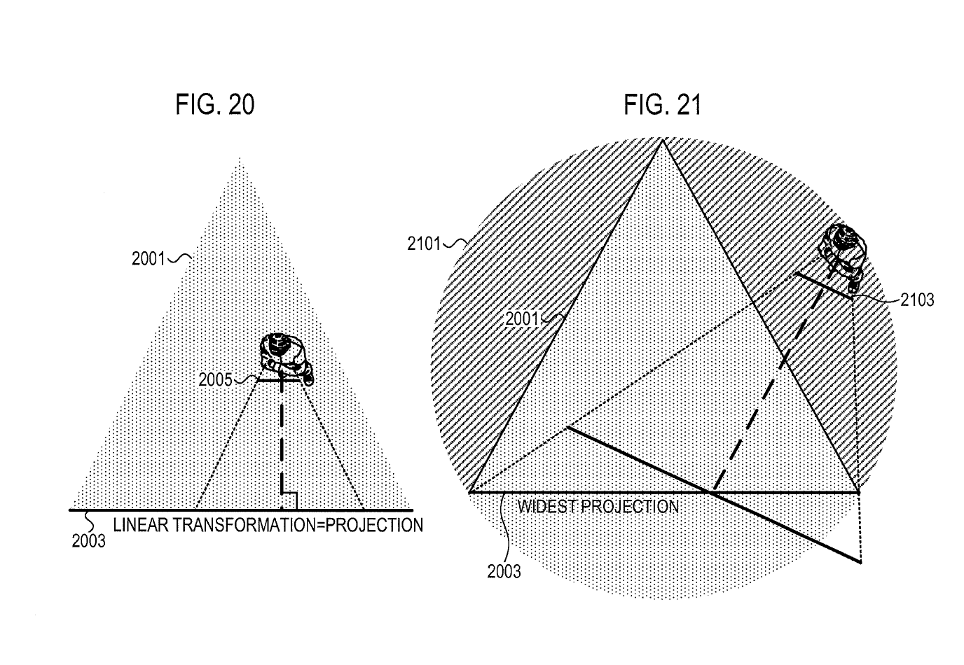

Referring to FIG. 20, the triangle of perpendicularity 2001 is defined by the triangle formed by the cone of viewing and the display surface 2003. An undistorted perception 2005 of the content can be obtained for any position within the triangle using only a translation and resizing of the 3D display.

Referring to FIG. 21, the disc of conservation 2101 is defined by the circle that intersects with the corners of the triangle of perpendicularity 2001. An undistorted perception 2103 of the content can be obtained for any position within the disc 2101 (and outside the triangle 2001) using translation, resizing and rotation of the 3D display.

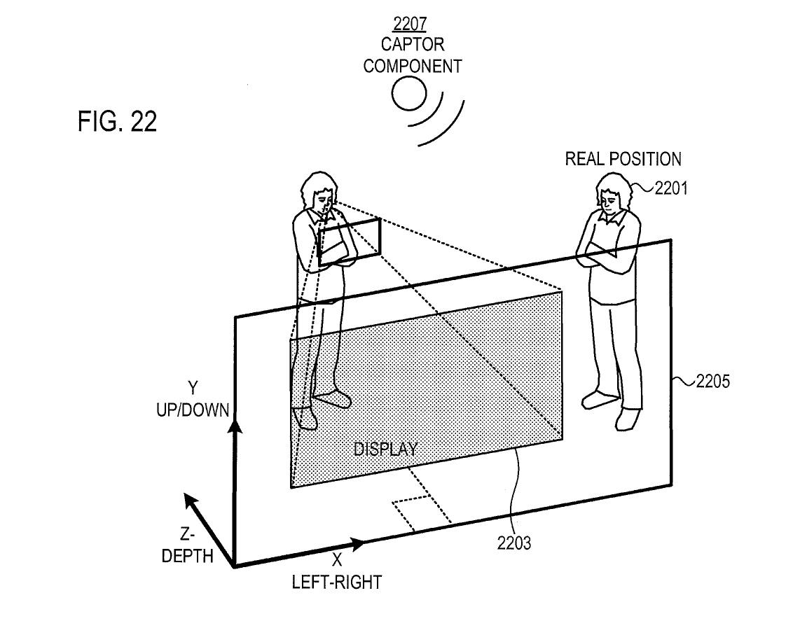

Referring to FIG. 22, which depicts a system according to embodiments of the present invention, a viewer 2201, display surface 2203 and displayed content 2205 share the same 3D Euclidean coordinate space. A captor component 2207 tracks the real time position of a viewer's head (defined to be (Xᵣₑ, Yᵣₑ, Zᵣₑ). The size of the display surface (X_{surface}, Y_{surface}), the position of the captor component 2207 in relation to the display surface, and the theoretical ideal angle for viewing an item of content (αₜₕ) (which can define an ideal size for displaying the content (Xₜₕ, Yₜₕ) for a given distance from the display surface (Zₜₕ) or an ideal distance for displaying the content (Zₜₕ) for a given size of displaying the content) are all typically provided to the system. In alternative embodiments, an ideal size and/or position for displaying the content can be explicitly provided. A controller (not shown) calculates the 3D object covering the viewing cone according to the viewer's real time position. A renderer component (not shown) displays the final perspective projection on the display surface. In the present embodiment, the captor component comprises a 3D depth-camera device (such as Kinect or PrimeSense device) and a C++ software module running on a Linux server which takes as input real-time depth map video for detecting and calculating user-body skeletons in order to deduce the position of a viewer's heads.

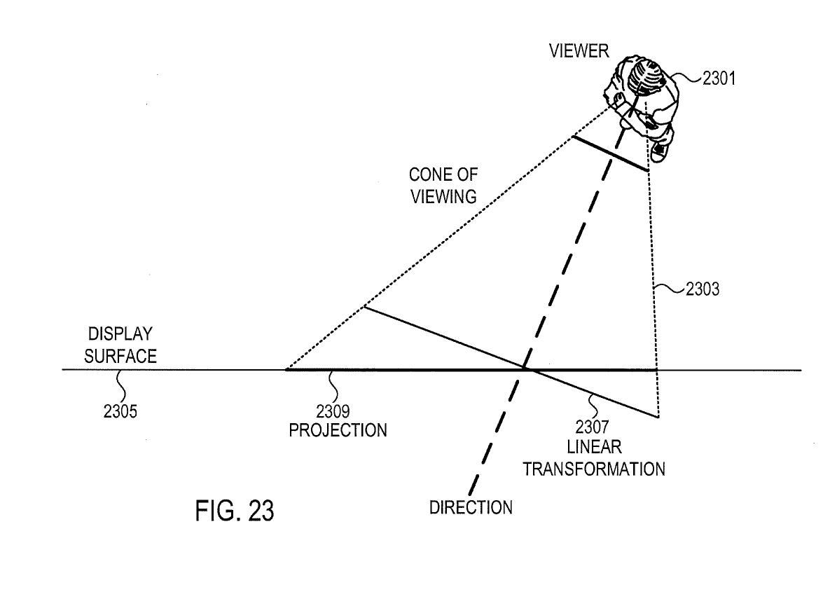

In order to explain how the transformation parameters are derived, the problem will be reduced to a two-dimensional problem in the X- (left/right) and Z- (depth) dimensions. It will be apparent to the skilled person how to extend the two-dimensional to the three-dimensional domain including the Y-dimension (up/down). FIG. 23, depicting the environment as viewed from above the viewer 2301, shows the viewing cone 2303, display surface 2305, linear transformation of the 3D object 2307 and projection of the linear transformation 2309 onto display surface 2307.

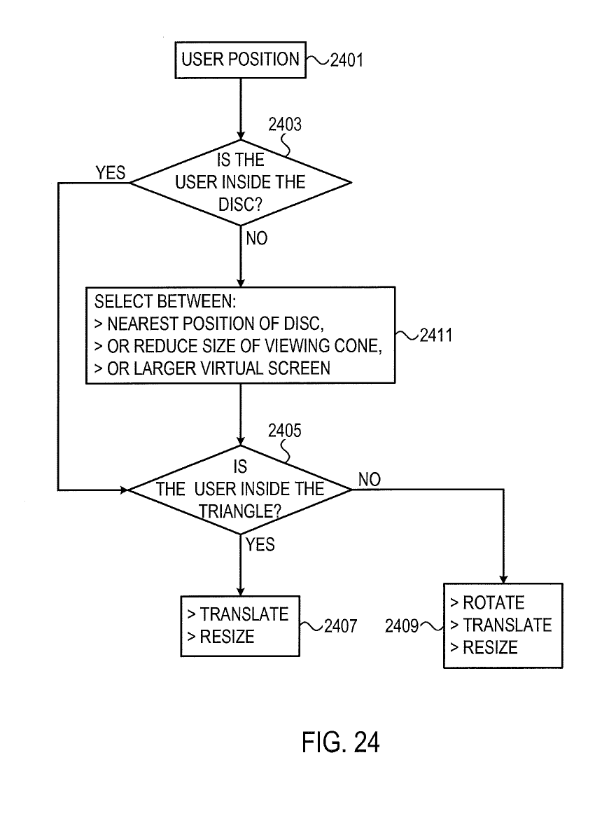

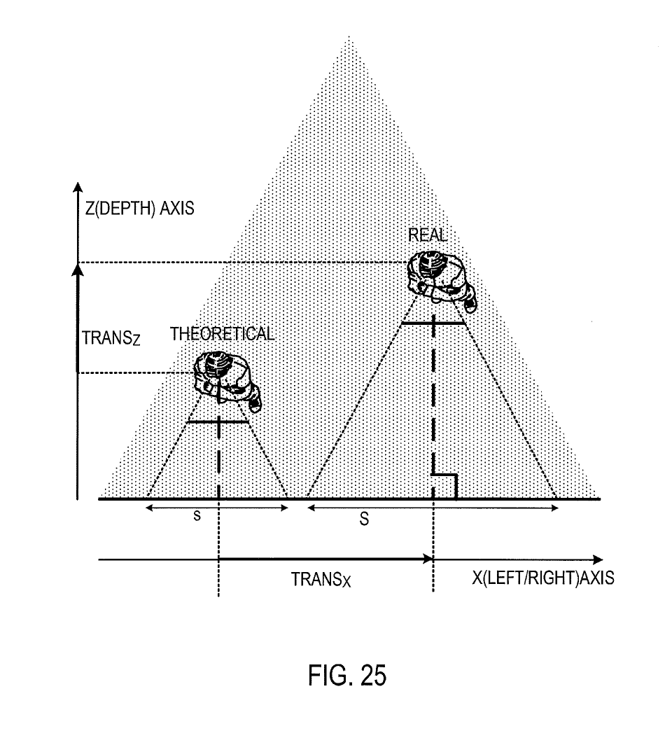

Referring to the flow chart in FIG. 24, the real time position of the viewer's head is initially acquired (step 2401). It will be remembered that in the present embodiment, the theoretical angle for viewing an item of content and the display surface size will have already been provided to the system. Using this theoretical angle and display surface size, the system is able to define sizes of both the triangle of perpendicularity and the disc of conservation. The system then checks if the user is inside the disc (step 2403) using the real time position of the viewer's head. If the user is inside the disc, the system further checks whether the user is inside the triangle (step 2405). If the user is inside the triangle, then it will be remembered that an undistorted perception of the content can be obtained for any position within the triangle using only a translation and resizing of the 3D display. Referring to FIG. 25, the translation parameter is given by:

Trans_{X}=Xᵣₑ−Xₜₕ

The resizing parameter is given by:

S=s*Zᵣₑ/Zₜₕ

Thus:

S=s+Trans_{Z}/Zₜₕ

The 3D object is then transformed (i.e. translated and resized (step 2407)) using the translation and resizing parameters. If the initial coordinates of a point in the 3D object are (X₀, Y₀, Z₀) then the transformed coordinates of the transformed 3D object are (X, Y, Z).

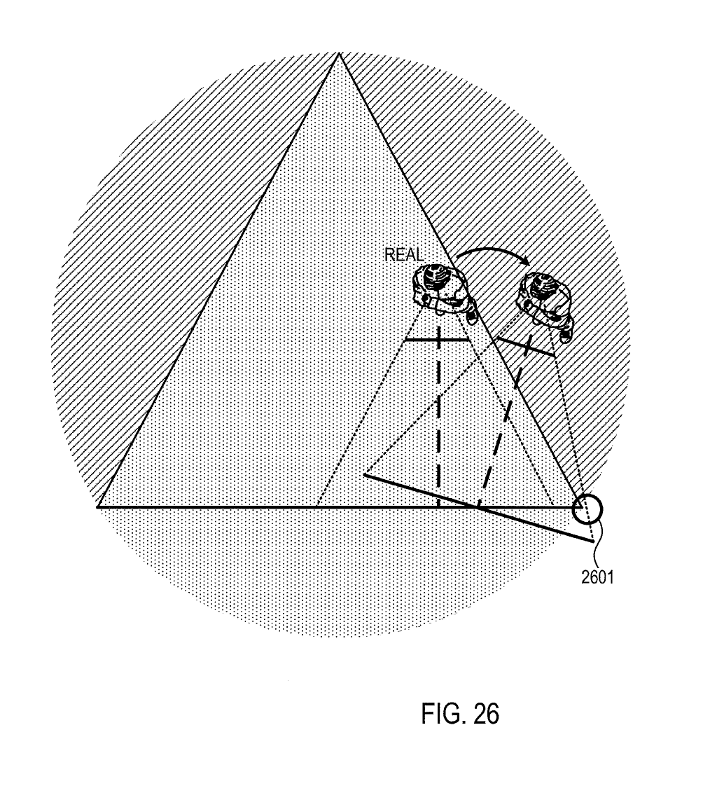

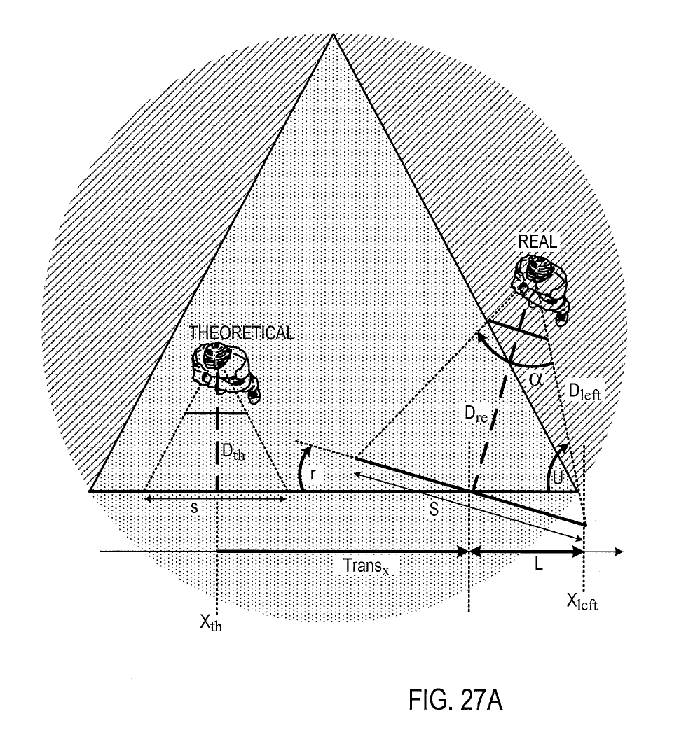

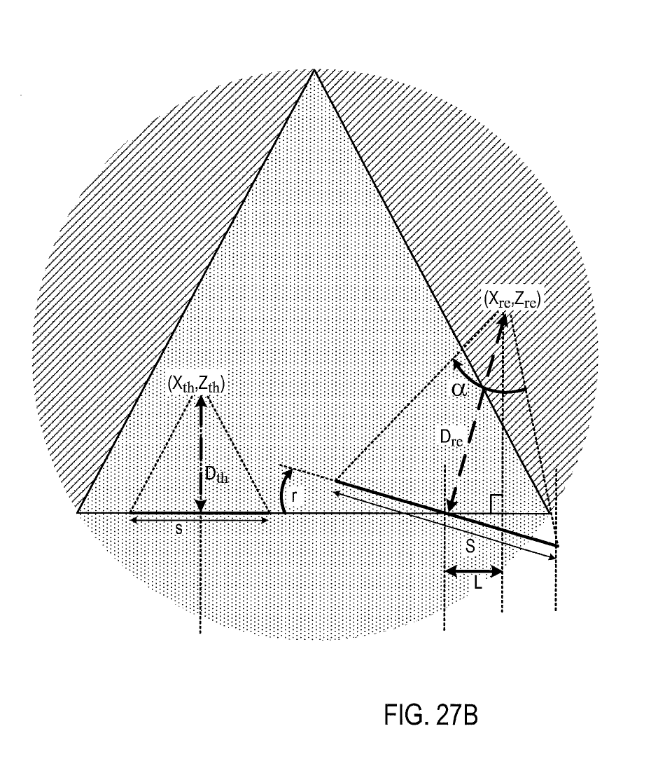

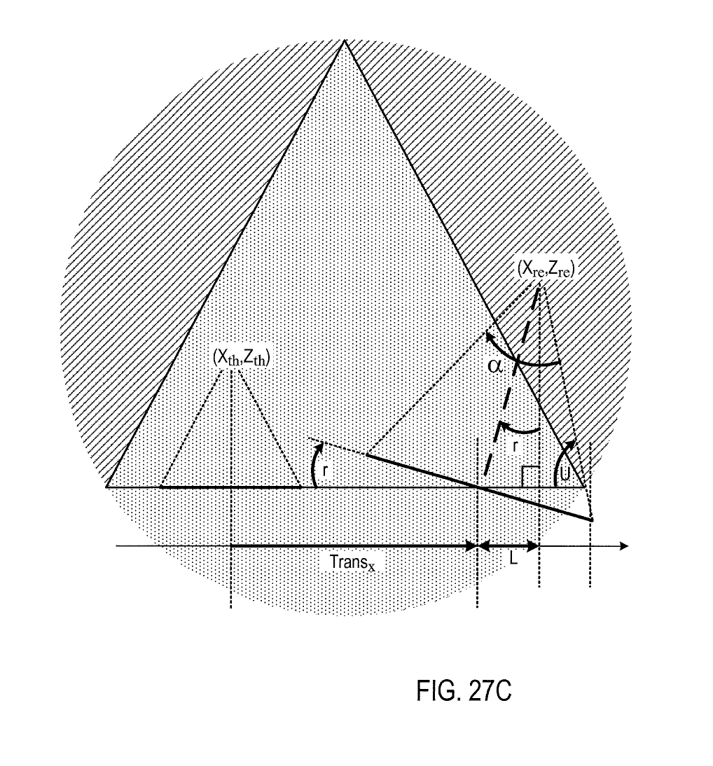

However, if the user is inside the disc but not inside the triangle, then it will be remembered that an undistorted perception of the content can be obtained for any position within the disc (and outside the triangle) using translation, resizing and rotation of the 3D display. Referring to FIG. 26, the direction is defined by the left-right border of the viewing cone meeting the left/right extremity of the display surface as indicated by point 2601. Referring to FIG. 27a, the translation parameter is given by:

Trans_{X}=X_{left}−L−Xₜₕ
where L=(sin(α/2)*D_{left})/sin(180−u−α/2)
(for α and u measured in degrees)
   The resizing parameter is given by:

S=s*Dᵣₑ/Dₜₕ
where Dᵣₑ=(sin(u)*L)/sin(α/2)
   The rotation parameter (in degrees) is given by:

r=α/2+u−90

According to an alternative calculation, and referring to FIGS. 27b and 27c, the translation parameter is given by:

Transₓ=Xᵣₑ−Xₜₕ−Zₜₕ/tan(180−u−α/2)
(for α and u measured in degrees)
   The resizing parameter is given by:

S=(s/Zₜₕ)*Zᵣₑ*√(1+tan(180−u−α/2)²)
(for α and u measured in degrees)

The 3D object is then transformed (i.e. rotated, translated resized (step 2409)) using the rotation, translation, resizing parameters.

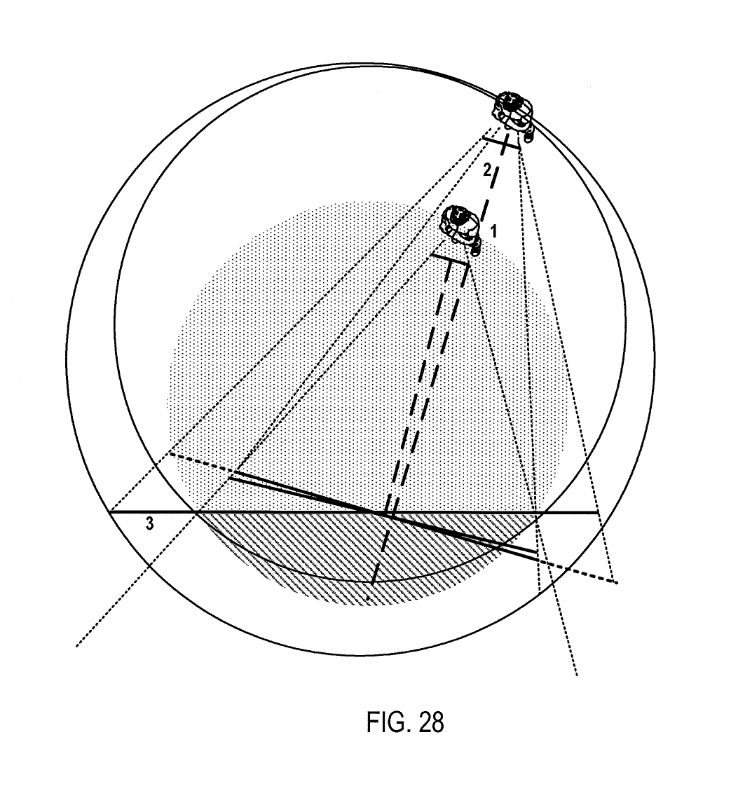

If the user is not inside the disc of conservation then the display surface is too small to present the content in such a way that the user will have an undistorted perception of the content once transformed and projected. Referring to FIG. 28, the system can then choose between three different options (step 2411):
1. Use the nearest position to the viewer on the edge of the disc (indicated as option 1 in FIG. 28);
2. Enlarge the disc of conservation by reducing the size (i.e. the angle α) of the original viewing cone (indicated as option 2 in FIG. 28); or
3. Enlarge the disc of conservation by virtually enlarging the display surface with hidden parts at each edge of the display surface (indicated as option 3 in FIG. 28).

The system then proceeds to step 2405 (i.e. checks whether the user is within the triangle).

It will be remembered from FIG. 15c that the third stage involves projecting the transformed 3D display onto the display surface. It will also be remembered that the transformed coordinates of the transformed 3D object can be denoted (X, Y, Z).

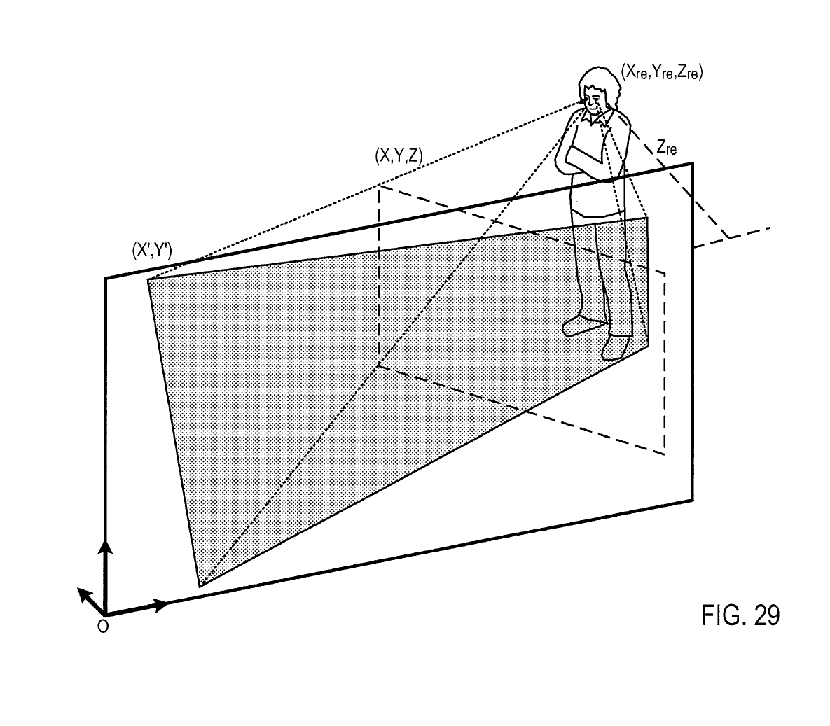

Referring to FIG. 29, the coordinates for what is rendered on display surface (X′, Y′) are given by:

X′=X*Zᵣₑ/Z−Xᵣₑ

Y′=Y*Zᵣₑ/Z−Yᵣₑ

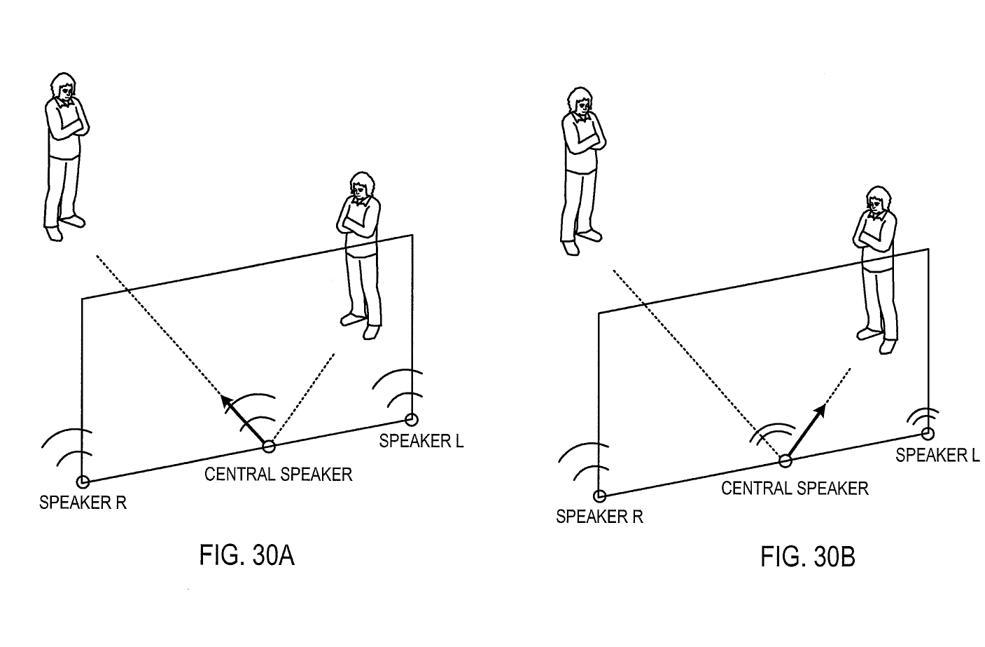

In parallel to the viewing aspect described previously, the perception of audio is typically different from one viewing (or listening) position to another, causing a distortion of the original sound as it is expected to be head from a central viewing (or listening) position. FIG. 30a depicts a simplified audio set up for a viewer at a central position (i.e. the position from which listening is expected to occur). Knowing the position of the user, the same components as described above can be used to identify the direction of the user and the distance of the user from the audio system (i.e. from the various speakers that output the audio). An additional system component can then translate the direction and modify the amplitude of the audio in order to target the user and make the user perceive the audio as if the user was listening from the central position for which the audio was produced; and in order to make the user perceive the audio at the same volume from any position. This is depicted in FIG. 30b which shows how the direction of the audio and the amplitude from three speakers can be adjusted when the user is listening from a position other than the central position.

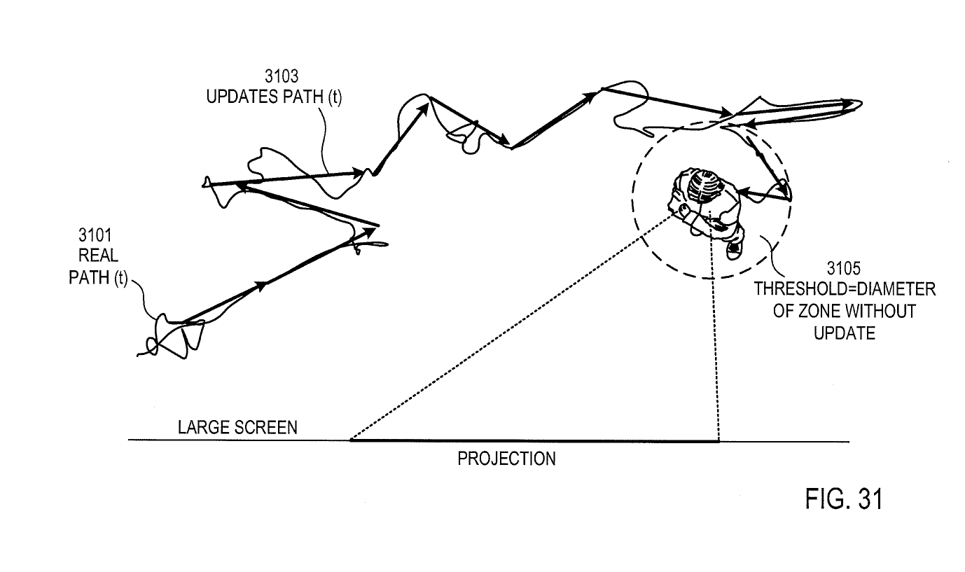

The method of viewer perspective correction as described above, according to embodiments of the present invention, can also takes into account the fact that a viewer may move to a new position while watching an item of content. In order to avoid constant updates, a change threshold is set so that an update takes place at certain points on the user's path and not at every point. This is depicted in FIG. 31, which shows a user's real path 3101, the path the user is assumed to have taken 3103 taking into account the change threshold, and a threshold 3105. For example, when the user sits on a chair, the display (and sound) is typically updated once and then not again until the user leaves the chair. While the user is sitting on the chair, the user can move his head or change position on the chair without causing the display to update.

When the display is updated, this is typically done smoothly with a timed transition (typically lasting a few seconds) in order to avoid an abrupt change of display. For stereoscopic 3D content, the system can additionally adapt the perspective correction. For instance, the difference between the two (left and right) pictures making up the stereoscopic picture can be compensated with changes along the Z-axis. That is, the left/right difference between the two pictures will typically increase as the user gets closer to the display surface to accentuate the 3D stereoscopic effect as would be expected when getting closer to the focus point.

It is becoming increasingly common for television systems to accept voice/gesture commands as an input method to control the television viewing experience. The television is able to indicate to the user that it has ‘heard’ (i.e. received) a voice command either by presenting a textual confirmation that a command has been received or by an audio indicator visually displaying the gain caused by the user's voice. However, this solution indicates that something has been said or perhaps what has been said rather than who said it. In the case where there is more than one user is in the room and potentially, therefore, more than one user interacting with the television, it would be useful for there to be an indication that the television is aware which of the users is currently speaking and ‘in control’ of the television.

A solution to this problem, according to embodiments of the present invention, is for the television user interface to visually skew towards the user that is speaking to control television. As different users speak, the user interface in effect “looks” at the user speaking, by swiveling away from the old speaker to the current speaker. This is possible using the systems described above which can detect which users are in a particular viewing environment and where they (i.e. their position within the viewing environment).

The above described methods for viewer perspective correction may also be used to determine how to present the content so that the user perceives the user interface ‘skewing’ towards them. The exact angle of skew is not important and typically the user interface does not skew so much that it has any effect on the visual readability of the user interface. If there are two users in the viewing environment, there are typically two angles of display for the user interface. Should another user enter the viewing environment, the system calculates the position of the newest user within the viewing environment and adds a third angle of display for the user interface. There is thus provided in accordance with embodiments of the present invention a system/method for adapting the presentation of content in a variable viewing environment are described. A viewer's changing levels of immersion & interactivity can be monitored and used to adapt the presentation of content.

The presentation can be adapted according to:

content metadata;

specifically authored content metadata;

contextually relevant information;

number, size and location of the Surfaces;

real-time analysis of the viewing environment, including viewer identification, viewer position, viewer engagement, and environmental properties; and/or

domotic inputs (e.g. baby (video) monitor; door bell; etc.);

explicit user control; etc.

Visual presentation of multimedia content (e.g. target surface, location, size, position, brightness, chroma, colour balance, dynamic range etc.); audio presentation of multimedia content (e.g. volume, dynamic range, position, etc.); and other home devices (e.g. lighting levels, telephone, etc.) can be dynamically controlled in a variable viewing environment, that is, one where shared Surfaces, or personal or shared companion devices or even individual displays can be added to or removed from the viewing environment on ad-hoc basis.

The range of multimedia content shown on such a variable viewing environment can include, but is not limited to: broadcast and/or on-demand audio video content; domotic content and feeds (e.g. photos, in-home webcams, (baby) monitors, etc.); online media (including over-the-top audio/video services, news feeds & social network feeds, etc.)

Presentation of content can also be adapted in response to external inputs (e.g. domotic video feeds, telephone, instant messaging, social network and news feeds, etc.) based on the viewer's levels of immersion & interactivity.

The presentation may also operate in an idle, or ambient, mode where the Surface(s) have not been explicitly requested to display content. In this mode, the displayed content could be used to simulate photographs on a wall, news and social network updates or even videos simulating a window.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather, the scope of the invention is defined by the claims.

1. A method of operating a client device within a viewing environment comprising at least one display surface in operable communication with said client device, said method comprising:
receiving content at said client device;
presenting said content to a viewer by rendering said content as rendered content on said at least one display surface;
evaluating a plurality of received signals indicating a level of engagement with said rendered content of said viewer to determine an immersion level of said viewer in said rendered content; and
adapting presentation of said rendered content on said at least one display surface in dependence on said determined immersion level of said user, metadata associated with said rendered content and domotic inputs received from a home automation system in operable communication with said client device.

2. The method of claim 1, wherein said rendered content is presented at a location on said at least one display surface and said adapting comprises changing said location where said rendered content is presented.

3. The method of claim 1, wherein said rendered content is presented at a size on said at least one display surface and said adapting comprises changing said size at which said rendered content is presented.

4. The method of claim 1, wherein said rendered content is presented across a plurality of display surfaces and said adapting comprises changing which of said plurality of display surfaces said rendered content is presented on.

5. The method of claim 4, further comprising temporally synchronising said presentation of said rendered content across said plurality of display surfaces.

6. The method of claim 5, wherein one of said plurality of display surfaces comprises a master and the remaining display surfaces in said plurality of display surfaces comprise slaves which are synchronised to said master.

7. The method of claim 1, wherein said adapting presentation of said rendered content comprises changing audio presentation of said rendered content by changing one or more of: audio level, audio dynamic range, audio position, audio balance.

8. (canceled)

9. The method of claim 1, wherein said metadata includes data to explicitly modify how said rendered content is to be presented.

10. The method of claim 9, wherein said metadata comprises a physical size at which to render said rendered content.

11. The method of claim 1, wherein adapting presentation of said rendered content additionally comprises changing a lighting level of said viewing environment.

12. The method of claim 1, wherein said rendering said content causes execution of a search query, said search query searching for additional content that is contextually relevant to said rendered content, and said adapting presentation of said rendered content further comprises simultaneously rendering said additional content with said rendered content.

13. The method of claim 12, wherein adapting presentation of said rendered content additionally comprises adapting presentation of said additional content.

14. The method of claim 1, wherein said immersion level is determined by evaluating a plurality of: audio signals in said viewing environment not caused by presenting said content; a position of said viewer in said viewing environment; a direction of gaze of said viewer; a degree of movement of said viewer; usage of a remote control device by said viewer; content previously viewed by said viewer; whether said content is being viewed live or a played back recording;
viewer behaviour during said presenting said content; user interaction with other electronic devices; a time of day of viewing said content.

15. The method of claim 1, wherein said immersion level is determined from data input by said viewer explicitly defining said immersion level.

16. The method of claim 1, further comprising transmitting a representation of how said content is presented on said display surface to a handheld device in operable communication with said client device; and displaying said representation on said handheld device.

17. The method of claim 16, wherein said representation comprises a link to further content that is contextually relevant to said content, said method further comprising receiving a selection of said link by said viewer; sending a request for said further content on receiving said selection; receiving said further content; and presenting said further content to said viewer.

18. The method of claim 16, said method further comprising: receiving a message from said handheld device indicating that said viewer has modified said representation; and further adapting presentation of said content on said display surface in response to said message.

19. (canceled)

20. The method of claim 1, wherein said adapting presentation of said rendered content in response to said domotic inputs comprises interrupting presentation of said rendered content to present said domotic inputs.

21. The method of claim 20, wherein said interrupting presentation of said rendered content occurs only if said immersion level is less than an interrupt threshold.

22. The method of claim 1, wherein said content comprises a plurality of content components each presented at a location and size on said display surface, and said adapting presentation of said content comprises changing the location and/or size for at least one of said plurality of said content components.

23-25. (canceled)

26. A client device comprising:
a layout manager operable to arrange content on at least one display surface in operable communication with said client device in response to a viewer request to view said content; and
at least one surface renderer operable to render said content onto said at least one display surface under control of said layout manager;
wherein said layout manager is further operable to: evaluate a plurality of signals indicative of said viewer's level of engagement to determine an immersion level of said viewer in said content; and adapt presentation of said content on said at least one display surface in dependence on said determined immersion level of said viewer, metadata associated with said content and domotic inputs received from a home automation system in operable communication with said client device.
